(19) United States
(12) Patent Application Publication
(10) Pub. No.: US 2022/0316151 A1
(43) Pub. Date: Oct. 6, 2022

(54) VEHICLE, APPARATUS AND METHOD

(71) Applicant: A2E INDUSTRIES LIMITED, Manchester (GB)

(72) Inventors: Alec BURNS, Manchester (GB); Paolo PAOLETTI, Manchester (GB); Sebastiano FICHERA, Manchester (GB)

(21) Appl. No.: 17/597,305

(22) PCT Filed: Jul. 1, 2020
(86) PCT No.: PCT/GB2020/051576

§ 371 Date: Dec. 31, 2021

(30) Foreign Application Priority Data
Jul. 1, 2019 (GB) 1909477.0

(51) Int. Cl. E01C 19/17; B25J 5/00

(52) U.S. Cl. CPC E01C 19/17; B25J 5/005

(57) ABSTRACT

A vehicle (1), preferably an unmanned and/or autonomous vehicle, for example a robot, the vehicle (1) comprising: a propulsion system (10), arranged to propel the vehicle (1), comprising a set of wheels (11) including a first wheel (11A) and/or a set of tracks (12) including a first track (12A); a deposition apparatus (20) for depositing a foam F comprising a polymeric composition (PC); and a controller (30) arranged to control the deposition apparatus (20) and optionally, the propulsion system (10); wherein the deposition apparatus (20) comprises: a set of reservoirs (100), including a first reservoir (100A) and a second reservoir (100B) arranged to receive therein a first component (C1) and a second component (C2) of the polymeric composition (PC), respectively; optionally a set of pumps (200), including a first pump (200A) and a second pump (200B) arranged to pump the first component (C1) and the second component (C2) from the first reservoir (100A) and the second reservoir (100B), respectively; a blending chamber (300) in fluid communication with the set of reservoirs (100) via a set of inlet passageways (400), including a first inlet passageway (400A) and a second inlet passageway (400B), wherein the blending chamber (300) is arranged to blend the first component (C1) and the second component (C2) thereinto provide a precursor (P) of the poly-meric composition (PC); and a set of deposition nozzles (500) in fluid communication with the blending chamber (300) via a set of outlet passageways (600) including a first outlet passageway (600A), the set of deposition nozzles (500) including a first deposition nozzle (500A) comprising a static mixer (700A) arranged to mix the precursor (P) to generate the foam (F), at least in part, therefrom.

### FIELD

The present invention relates to a vehicle and an apparatus for, and to a method of, depositing a foam.

### BACKGROUND TO THE INVENTION

Disaster scenarios consider the aftermath of an event, such as a sudden accident or a natural catastrophe, that causes great damage or loss of life. According to a U.N. report, hundreds of floods, storms, heat waves and droughts have left over 600,000 people dead and 4.1 billion injured or homeless around the world since 1995.

When a disaster strikes, it is critical to find victims and deploy assistance to survivors as quickly as possible. People stranded after an earthquake or hurricane or who are living in a war zone are often stuck for days without food, water or medicines. Infrastructures are usually collapsed in these situations, making it hard for rescuers to reach the afflicted areas to dispense assistance and necessities. Due to this, first responders are often exposed to significant risks during the relief efforts, often entering highly unstable areas with scarce knowledge of structural integrity of buildings and their interiors.

Aerial, terrestrial and maritime robotic systems can potentially assume a key role mitigating the risks associated with disaster relief, search and rescue and salvage operations, while simultaneously ensuring safety of both first responders and survivors. In fact, robots can be deployed quickly in areas deemed too unsafe for humans and can be used to guide rescuers, collect data, deliver essential supplies or provide communication services. Many projects have been developed in recent years to tackle some of the most pressing issues. However, taking terrestrial robotic platforms from the often predictable even surfaces in a lab to the disaster-zone environments, is hindered by one of their greatest shortfalls: overcoming obstacles.

Several robot platforms have been proposed for driving and climbing on rough terrain, and can be categorised into five main classes: single-tracked, multi-tracked, wheeled, quadruped-platforms (or biologically inspired systems) and humanoid. Each class of platforms results in particular benefits, and drawbacks, for overcoming obstacles, such as ascending and/or descending steps or stairs and/or crossing chasms (i.e. trenches, gaps and/or crevices). Hybrid platforms have been proposed to maximise the advantages of their constituent architectures, but such hybrid platforms are often costly and their added benefits limited. A comparison of tracked, wheeled, humanoid and their respective hybrids is summarised in Table 1. Quadruped and biologically inspired platforms are not included in the table, as these classes represent a very diverse array of systems which are not readily generalised.

TABLE 1
Comparative summary of locomotion system performance.

| | W | T | Leg | LeW | LeT | WT |
|---|---|---|---|---|---|---|
| maximum | H | M/H | L | M/H | M | M/H |
| speed | | | | | | |
| obstacle | L | M/H | H | M/H | H | M |
| crossing | | | | | | |
| step | L | M | H | H | H | M |
| climbing | | | | | | |
| slope | L/M | H | M/H | M/H | H | M/H |
| climbing | | | | | | |
| soft terrain | L | H | L/M | L/M | M/H | H |
| uneven | L | M/H | H | H | H | M/H |
| terrain | | | | | | |
| energy | H | M | L | M/H | M | M/H |
| efficiency | | | | | | |
| system | L | L | H | M/H | M/H | L/M |
| complexity | | | | | | |

W: Wheeled, T: Tracked, Leg: Legged, LeW = Legged Wheeled, LeT = Legged Tracked, WT = Wheeled Tracked.
L = Low, M = Medium and H = High.

As can be seen from Table 1, no robot platform has so far been proven to outperform the rest. Hence, there is a need to improve overcoming of obstacles, such as ascending and/or descending steps or stairs and/or crossing chasms (i.e. trenches, gaps and/or crevices).

### SUMMARY OF THE INVENTION

It is one aim of the present invention, amongst others, to provide a vehicle which at least partially obviates or mitigates at least some of the disadvantages of the prior art, whether identified herein or elsewhere. For instance, it is an aim of embodiments of the invention to provide a vehicle that may better overcome obstacles. For instance, it is an aim of embodiments of the invention to provide a deposition apparatus that may better deposits foams, for example to better fill voids.

A first aspect provides a vehicle, preferably an unmanned and/or autonomous vehicle, for example a robot, the vehicle comprising:

a propulsion system, arranged to propel the vehicle, comprising a set of wheels including a first wheel and/or a set of tracks including a first track;

a deposition apparatus for depositing a foam comprising a polymeric composition; and a controller arranged to control the deposition apparatus and optionally, the propulsion system; wherein the deposition apparatus comprises:

a set of reservoirs, including a first reservoir and a second reservoir arranged to receive therein a first component and a second component of the polymeric composition, respectively; optionally a set of pumps, including a first pump and a second pump arranged to pump the first component and the second component from the first reservoir and the second reservoir, respectively;

a blending chamber in fluid communication with the set of reservoirs via a set of inlet passageways, including a first inlet passageway and a second inlet passageway, wherein the blending chamber is arranged to blend the first component and the second component therein to provide a precursor of the polymeric composition; and

a set of deposition nozzles in fluid communication with the blending chamber via a set of outlet passageways including a first outlet passageway, the set of deposition nozzles including a first deposition nozzle comprising a static mixer arranged to mix the precursor to generate the foam, at least in part, therefrom.

A second aspect provides a method of controlling a vehicle according to the first aspect to deposit a foam comprising a polymeric composition, the method comprising:

blending, using the blending chamber, the first component and the second component of the polymeric composition to provide the precursor of the polymeric composition;

generating the foam, at least in part, by mixing, using the static mixer included in the first deposition nozzle, the precursor; and

depositing the foam, at least in part, via the first deposition nozzle.

A third aspect provides a deposition apparatus for depositing a foam comprising a polymeric composition, the deposition apparatus comprising:

a set of reservoirs, including a first reservoir and a second reservoir arranged to receive therein a first component and a second component of the polymeric composition, respectively; optionally a set of pumps, including a first pump and a second pump arranged to pump the first component and the second component from the first reservoir and the second reservoir, respectively;

a blending chamber in fluid communication with the set of reservoirs via a set of inlet passageways, including a first inlet passageway and a second inlet passageway, wherein the blending chamber is arranged to blend the first component and the second component therein to provide a precursor of the polymeric composition; and

a set of deposition nozzles in fluid communication with the blending chamber via a set of outlet passageways including a first outlet passageway, the set of deposition nozzles including a first deposition nozzle comprising a static mixer arranged to mix the precursor to generate the foam, at least in part, therefrom.

A fourth aspect provides a method of depositing a foam comprising a polymeric composition, the method comprising:

blending, using a blending chamber, a first component and a second component of the polymeric composition to provide a precursor of the polymeric composition;

generating the foam, at least in part, by mixing, using a static mixer included in a first deposition nozzle, the precursor; and

depositing the foam, at least in part, via the first deposition nozzle.

A fifth aspect provides use of a blending chamber to blend a first component and a second component of a polymeric composition to provide a precursor of the polymeric composition prior to generating a foam, at least in part, from the precursor using a static mixer.

### DETAILED DESCRIPTION OF THE INVENTION

According to the present invention there is provided a vehicle, as set forth in the appended claims. Also provided is a method of controlling a vehicle, an apparatus for depositing a foam, a method of depositing a foam and use of a blending chamber. Other features of the invention will be apparent from the dependent claims, and the description that follows.

Vehicle

The first aspect provides a vehicle, preferably an unmanned and/or autonomous vehicle, for example a robot, the vehicle comprising:

a propulsion system, arranged to propel the vehicle, comprising a set of wheels including a first wheel and/or a set of tracks including a first track;

a deposition apparatus for depositing a foam comprising a polymeric composition; and

a controller arranged to control the deposition apparatus and optionally, the propulsion system;

wherein the deposition apparatus comprises:

a set of reservoirs, including a first reservoir and a second reservoir arranged to receive therein a first component and a second component of the polymeric composition, respectively; optionally a set of pumps, including a first pump and a second pump arranged to pump the first component and the second component from the first reservoir and the second reservoir, respectively;

a blending chamber in fluid communication with the set of reservoirs via a set of inlet passageways, including a first inlet passageway and a second inlet passageway, wherein the blending chamber is arranged to blend the first component and the second component therein to provide a precursor of the polymeric composition; and

a set of deposition nozzles in fluid communication with the blending chamber via a set of outlet passageways including a first outlet passageway, the set of deposition nozzles including a first deposition nozzle comprising a static mixer arranged to mix the precursor to generate the foam, at least in part, therefrom.

In this way, the vehicle may better overcome obstacles, such as ascending and/or descending steps or stairs and/or crossing chasms (i.e. trenches, gaps and/or crevices), because the vehicle may deposit foam in the path thereof so as to overcome the obstacles. For example, the vehicle may deposit the foam to provide a ramp so as to better ascend and/or descend steps or stairs. For example, the vehicle may deposit the foam to at least partially fill a chasm so as to provide a path thereacross. In this way, ground robots may traverse uneven terrains and overcome obstacles. In this way, disaster relief, search and rescue and/or salvage operations may be facilitated, thereby helping survivors more quickly while better ensuring safety of both first responders and survivors. More generally, the vehicle may be utilised for other applications requiring filling of voids and/or provision of paths, including depositing insulation in buildings, building bridges or pontoons on water, repairing buildings including repairing cracks in roofs, repairing damaged utility pipes and/or military applications. Particularly, the deposition apparatus, as included on the vehicle and as developed by the inventors, has been found to overcome also limitations of conventional deposition apparatuses, allowing improved control of foam properties and improved uniformity of deposition while also having improved robustness to blockages.

As described below in more detail, the blending chamber blends the first component and the second component, thereby at least partially homogenizing the first component and the second component, without generating the foam, thus improving distribution of the first component and the second component to the set of deposition nozzles. Generation of the foam is subsequently from the precursor by mixing thereof using the static mixer in the first deposition nozzle.

Vehicle

The first aspect provides the vehicle, preferably an unmanned and/or autonomous vehicle, for example a robot.

In one example, the vehicle is a land craft. In one example, the land craft is a two-wheeled vehicle such as a scooter or a motorbike, a three-wheeled vehicle, a four-wheeled vehicle such as an automobile, a van, a bus, a truck, a forklift truck, a military vehicle, or a vehicle having more than two axles, such as a lorry, a tram or a train. In one example, the land craft is a tracked vehicle, having continuous tracks, such as a recovery or rescue vehicle, a bulldozer, a tractor, a military vehicle such as a tank.

The vehicle is preferably an unmanned and/or autonomous vehicle for example a robot. Generally, an unmanned vehicle (also known as an uncrewed vehicle) is a vehicle without a person on board. An unmanned vehicle can either be a remote controlled vehicle (also known as a remote guided vehicle) or an autonomous vehicle, capable of sensing its environment and navigating autonomously. Unmanned vehicles include unmanned ground vehicles (UGV), such as autonomous cars. For example, autonomous cars (also known as self-driving cars) combine a variety of sensors to perceive their surroundings, such as RADAR, LIDAR, SONAR, GPS, odometry and inertial measurement units, while advanced control systems interpret the sensory information to identify appropriate navigation paths, as well as obstacles.

In one preferred example, the vehicle is a robot, such as a wheeled and/or a tracked robot, particularly a disaster relief robot, a search and rescue robot or a salvage robot. Generally, robots are machines, especially programmable by computers, capable of carrying out complex series of actions automatically. Robots may be controlled by external control devices or control may be embedded (i.e. autonomous robots).

In one example, the vehicle is an existing vehicle and the deposition apparatus is provided therefor, as a retrofit for example.

Propulsion System

The vehicle comprises the propulsion system, arranged to propel the vehicle, comprising a set of wheels including a first wheel and/or a set of tracks including a first track. In one example, the propulsion system comprises a set of legs including a first leg, in addition to or as an alternative to the set of wheels and/or the set of tracks. In one example, the set of wheels includes N wheels, including the first wheel, wherein N is a natural number greater than or equal to 1, for example 1, 2, 3, 4, 5, 6, 7, 8, 9, 10 or more, preferably 2, 4, 6, or 8. In one example, the set of tracks includes M tracks, including the first track, wherein M is a natural number greater than or equal to 1, for example 1, 2, 3, 4, 5, 6, 7, 8, 9, 10 or more, preferably 2, 4, 6, or 8. In one example, the propulsion system comprises a set of actuators, for example motors and/or engines, including a first actuator, arranged to actuate the set of wheels and/or the set of tracks (for example, by being coupled thereto), and hence propel the vehicle. In one example, the propulsion system comprises a power source, for example a battery, and/or a fuel supply.

Deposition Apparatus

The vehicle comprises the deposition apparatus for depositing the foam comprising the polymeric composition, as described below in more detail.

Reservoirs

The deposition apparatus comprises the set of reservoirs, including the first reservoir and the second reservoir arranged to receive therein the first component and the second component of the polymeric composition, respectively. As described below in more detail, foams comprising polymeric compositions may be formed by mixing two or more components. For example, polyurethane foam may be formed by mixing part A and part B (i.e. the first component and the second component of the polymeric composition, respectively). In one example, the first reservoir is arranged to receive therein the first component of the polymeric composition by comprising a plurality of walls forming a container (i.e. a vessel), for example an open or a closeable container, having no perforations therethough for leakage of the first component therefrom. Closeable containers are suitable for pressurised reservoirs, in which the respective components are urged therefrom by pressure, for example due to a pressurised gas. Open containers are suitable for pumped reservoirs, in which the respective components are urged therefrom by pumping, for example by a set up pumps. Preferably, open containers are also closeable so as to contain the respective components therein and/or prevent contamination thereof. The second reservoir may be arranged similarly.

Pumps

The deposition apparatus optionally comprises the set of pumps, including the first pump and the second pump arranged to pump the first component and the second component from the first reservoir and the second reservoir, respectively. In one example, the first pump comprises and/or is a positive displacement pump such as a rotary-type positive displacement pump, a reciprocating-type positive displacement pump or a linear-type positive displacement pump, an impulse pump, a velocity pump, a gravity pump, a steam pump and/or a valveless pump. In one example, the first pump comprises and/or is a syringe. Hence, the first pump and the second pump are arranged to pump the first component and the second component from the first reservoir and the second reservoir, respectively, by positive displacement thereof. In one example, the set of pumps comprises a first pump arranged to pump the the first component and the second component from the first reservoir and the second reservoir, respectively, for example by having two inlets and two outlets. Similarly, peristalitic pumps may be configured to separately pump two different fluids in two in two different tubes simultaneously.

In one preferred example, the first pump comprises and/or is a peristaltic pump. A peristaltic pump is a type of positive displacement pump. Fluid to be pumped is contained within a flexible tube fitted inside a circular pump casing (though linear peristaltic pumps have been made). A number of rollers, shoes, or wipers attached to a rotor serially compress (i.e. in turn) the flexible tube. As the rotor turns, the part of the tube under compression closes (or occludes), forcing the fluid through the tube. Additionally, when the tube opens to its natural state after the passing of the cam it draws (restitution) fluid into the pump. This process is called peristalsis and is used in many biological systems such as the gastrointestinal tract. Particularly, since the fluid to be pumped is contained within the flexible tubing, there is no contamination of the pump due to the fluid during pumping.

Blending Chamber

The deposition apparatus comprises the blending chamber in fluid communication with the set of reservoirs via the set of inlet passageways, including the first inlet passageway and the second inlet passageway, wherein the blending chamber is arranged to blend the first component and the second component therein to provide a precursor of the polymeric composition. The deposition apparatus comprises the set of deposition nozzles in fluid communication with the blending chamber via the set of outlet passageways including the first outlet passageway. That is, the blending chamber comprises the set of inlet passageways and the set of outlet passageways.

The blending chamber blends the first component and the second component, thereby at least partially homogenizing the first component and the second component, without generating the foam, thus improving distribution of the first component and the second component to the set of deposition nozzles. By distributing the first component and the second component to each deposition nozzle in a common (i.e. single) passageway, simplicity is improved, since fewer passageways and optionally pumps are required. However, in the absence of such blending, flow of the first component and the second component to the set of deposition nozzles is uneven, such that a ratio of the first component to the second component at the set of deposition nozzles is variable, as a function of time. Without wishing to be bound by any theory, it is thought that the respective viscosities, tackinesses and/or surface tensions of the first component and second component result in generally co-flow thereof, with only a small degree of blending, when introduced into a single passageway, rather than blending. Such variability in the ratio results in turn in variation of the mechanical properties of the foam and/or a curing time thereof. The inventors have determined that by blending the first component and the second component, before distribution to the set of deposition nozzles, such ratio variability is reduced or eliminated, resulting in more consistent mechanical properties of the foam and/or a curing time thereof. This is particularly relevant when the set of outlet passageways includes two or more outlet passageways, such that the blending chamber acts as a manifold. However, over-blending (i.e. mixing) of the first component and the second component results in generation of the foam, which is problematic if occurring in the set of outlet passageways, since blockage thereof results upon curing. Hence, generation of the foam during blending and within the set of outlet passageways is to be avoided, preferably entirely. Without wishing to be bound by any theory, it is thought that generation of the foam is dependent on turbulence of the blending, notwithstanding that foam generation is typically catalysed, as described below. Hence, the blending chamber balances sufficient blending to achieve a more uniform blend of the first component to the second component, so as to reduce variability in the ratio, which attenuating turbulence of the blending, so as to avoid generation of the foam. Particularly, the blending chamber is arranged to blend the first component and the second component therein to provide a precursor of the polymeric composition by having a shape (i.e. an internal shape) that promotes blending while attenuating turbulence therein. In one example, the blending chamber comprises a set of spherical or generally spherical chambers, including a first chamber and/or a second chamber, for example a pair thereof of mutually interconnecting chambers, such as directly interconnecting or indirectly interconnecting via an interconnecting passageway. In one example, the set of inlet passageways are fluidically coupled to the first chamber, for example mutually separated by an angle less than 180°, preferably in a range from 60° to 150° for example 120° such that the first component and the second component flow through the blending chamber together towards the set of outlet passageways. In one example, the set of outlet passageways are fluidically coupled to the second chamber. In one example, the interconnecting passageway has a cross-sectional dimension, for example a diameter, smaller than a diameter of the first chamber and/or the second chamber, for example having an aspect ratio in a range from 1:5 to 5:1. In one example, the blending chamber does not comprise a static mixer, for example a helical static mixer or a plate-type static mixer. In one example, the blending chamber comprises smooth internal walls, without any protuberances therefrom. In other words, the blending chamber is designed to provide low or no turbulent mixing.

Deposition Nozzles

The deposition apparatus comprises the set of deposition nozzles in fluid communication with the blending chamber via the set of outlet passageways including the first outlet passageway, the set of deposition nozzles including a first deposition nozzle comprising the static mixer arranged, for example a helical static mixer or a plate-type static mixer, to mix the precursor to generate the foam, at least in part, therefrom.

Deposition nozzles comprising static mixers are known. Suitable deposition nozzles comprising static mixers are available from Adhesive Dispensing Ltd (UK).

In one example, the set of deposition nozzles includes a second deposition nozzle in fluid communication with the blending chamber via a second outlet passageway of the set of outlet passageways. In this way, the foam may be deposited, for example simultaneously, from a plurality of deposition nozzles. Since the blending chamber blends is arranged to blend the first component and the second component therein to provide a precursor of the polymeric composition, the same precursor may be distributed to the plurality of deposition nozzles, thereby providing a more uniform blend of the first component to the second component at each deposition nozzle.

In one example, the first deposition nozzle is arranged (for example positioned) forwardly of the set of wheels, preferably forwardly of the first wheel, and/or forwardly of the set of tracks, preferably forwardly of the first track. In this way, the foam may be deposited in front of, for example only in front of, the set of wheels and/or the set of tracks to provide a ramp or a path, for example using a reduced and/or a minimised amount of foam. In one example, the first deposition nozzle is arranged rearwardly of the set of wheels, preferably rearwardly of the first wheel, and/or rearwardly of the set of tracks, preferably rearwardly of the first track. In one example, the first deposition nozzle is arranged (for example positioned) aligned with the set of wheels, preferably aligned with the first wheel, and/or aligned with the set of tracks, preferably aligned with the first track. In this way, the foam may be deposited directly in line with, for example only directly in line with, the set of wheels and/or the set of tracks to provide a ramp or a path, for example using a reduced and/or a minimised amount of foam.

Material

In one example, surfaces wetted by the first component, the second component, the precursor and/or the polymeric composition are formed from and/or coated with polytetrafluoroethylene (PTFE). In this way, build-up of residue thereof thereupon is reduced. In one example, the set of inlet passageways, the blending chamber, the set of outlet passageways and/or the set of deposition nozzles are formed from and/or coated (i.e. internal surfaces thereof) with PTFE.

Sensors

In one example, the vehicle comprises a set of sensors including a first sensor arranged (for example positioned) to sense an obstacle and to transmit a first signal to the controller, in response to sensing the obstacle. In one example, the first sensor comprises and/or is a proximity sensor, for example an inductive sensor, a capacitive sensor, a photoelectric sensor, an ultrasonic sensor, a retroreflective sensor or a diffuse sensor. In one example, the first sensor comprises an array of such sensors. Generally, proximity sensors detect the presence or absence of objects, such as obstacles, using electromagnetic fields light, and/or sound. In one example, the set of sensors includes S sensors, for example positioned as an array, wherein S is a natural number greater than or equal to 1 for example 1, 2, 3, 4, 5, 6, 7, 8, 9, 10 or more. In one example, the set of sensors is arranged (for example positioned) to sense an obstacle in a path of the vehicle, for example in front of, behind, below and/or above. Ultrasonic sensors are preferred. Suitable ultrasonic sensors are available from Acme Systems srl (Italy), such as the HC-SR04 ultrasonic sensor, having a sensed range from 2 cm to 400 cm.

Solvent

In one example, the set of reservoirs includes a third reservoir arranged to receive therein a solvent for cleaning the blending chamber, the set of outlet passageways and/or the set of deposition nozzles; optionally the set of pumps includes a third pump arranged to pump the solvent from the third reservoir; and the set of inlet passageways includes a third inlet passageway. In this way, the blending chamber, the set of outlet passageways and/or the set of deposition nozzles may be cleaned, for example periodically, so as to reduce build up of the first component, the second component, the precursor and/or the foam respectively therein. The solvent may be selected according to the first component, the second component, the precursor and/or the foam. For example, isopropyl alcohol is a suitable solvent for PU and the first and second components thereof. The third reservoir and/or the third pump may be as described with respect to the first reservoir and the first pump, respectively.

In one example, the deposition apparatus comprises a solvent recovery apparatus, optionally comprising a filter, for recovering and optionally filtering the solvent. In one example, the deposition apparatus comprises a solvent recovery pump for pumping the recovered and optionally filtered solvent to the third reservoir. In this way, solvent consumption is reduced while environmental contamination is avoided.

Controller

The vehicle comprises the controller arranged to control the deposition apparatus and optionally, the propulsion system. In one example, the controller comprises a processor and a memory and is arranged to control the deposition apparatus and optionally, the propulsion system, using software (i.e. programmatic instructions executed by the processor). In one example, the vehicle comprises a communications (wired and/or wireless) interface for onboard communication and/or communication with external devices.

In one example, the controller is arranged to receive, for example via the communications interface, the first signal transmitted by the first sensor and to control the propulsion system and/or the deposition apparatus, based, at least in part, on the received first signal. In this way, the controller may control the propulsion system and/or the deposition apparatus responsive to sensing of an obstacle, for example to slow, stop or change direction of propulsion and/or to start or stop deposition of foam.

In one example, the controller is arranged to control the propulsion system to control a speed and/or heading (i.e. direction, bearing, orientation) of the vehicle.

In one example, the controller is arranged to control the propulsion system to move the vehicle rearwardly or forwardly and to control the deposition apparatus to deposit the foam, based, at least in part, on the received first signal. For example, upon sensing of an obstacle, the controller may control the propulsion system to slow, stop and/or reverse the vehicle and to deposit the foam to provide a ramp or a path.

In one example, the controller is arranged to control the propulsion system to move the vehicle rearwardly and to control the deposition apparatus to deposit the foam, based, at least in part, on the received first signal, while the vehicle moves rearwardly. In this way, the controller may control the deposition apparatus to deposit the foam to provide a ramp, tapering away from the obstacle, such as a step.

In one example, the controller is arranged to control the deposition apparatus to deposit the foam, based, at least in part, on a distance from an obstacle, for example as determined from the received first signal. In one example, the controller is arranged to control a rate of deposition of the foam by the deposition apparatus, based, at least in part, on a distance from an obstacle, for example as determined from the received first signal. In this way, a ramp may be provided, tapering away from the obstacle, such as a step.

In one example, the controller is arranged to control the propulsion system to move the vehicle forwardly after depositing the foam. In this way, the vehicle may overcome the obstacle, for example a step, by moving up a ramp provided by the deposited foam.

In one example, the controller is arranged to control the propulsion system and/or the deposition apparatus to repeatedly move the vehicle and/or deposit the foam. In this way, the vehicle may overcome a relatively larger obstacle.

In one example, the controller is arranged to control the propulsion system to move the vehicle forwardly and to control the deposition apparatus to deposit the foam, based, at least in part, on the received first signal, optionally while the vehicle moves forwardly. In this way, a chasm may be at least partially filled, for example.

In one example, the controller is arranged to control a speed of the set of pumps, for example respective speeds of the first pump and the second pump, for example as a function of time. In this way, a rate of deposition of the polymeric composition may be controlled, for example to provide a ramp. In one example, the controller is arranged to control a speed of the set of pumps, for example respective speeds of the first pump and the second pump independently. In this way, a ratio of the first component to the second component may be controlled, thereby controlling a mechanical property and/or a curing time of the deposited polymeric composition. In one example, the controller is arranged to control a deposition pattern of the polymeric composition deposited by the deposition apparatus, such as to fill a cavity and/or define a ramp, for example by controlling the deposition apparatus and optionally, the propulsion system, for example synchronously (i.e. in a coordinated manner). In one example, the deposition pattern comprises one or more lines of deposited polymeric composition. In one example, the deposition pattern comprises one or more points of deposited polymeric composition, for example defining a matrix of deposited polymeric composition. In one example, the deposition pattern comprises one or more layers of deposited polymeric composition.

In one example, the controller is arranged to calculate a distance from the object, based, at least in part, on the first signal. In one example, the controller is arranged to calculate a depth and/or a volume of a void, such as a chasm, based, at least in part, on the first signal. In one example, the controller is arranged to calculate an amount of the first component and/or the first component to be deposited as the polymeric composition based, at least in part, on the first signal, for example by using the volume of the void to be filled and an expected expansion of the foam.

Machining

In one example, the deposition apparatus comprises a machine tool, for example a mill, a drill or a cutter, arranged to machine, for example mill, drill and/or cut, the foam. In this way, a surface of the foam may be machined, such as to facilitate further deposition of foam thereabove and/or to provide a required shape of the foam. In one example, the controller is arranged to control the machine tool.

Foam

The foam (also known as a polymeric foam) comprises the polymeric composition. Generally, polymeric foams are foams, in liquid or solidified form, formed from polymers. In one example, the foam comprises and/or is ethylene-vinyl acetate (EVA) foam (copolymers of ethylene and vinyl acetate, also known aspolyethylene-vinyl acetate (PEVA)), low-density polyethylene (LDPE) foam (first grade of polyethylene (PE)), nitrile rubber (NBR) foam (copolymers of acrylonitrile (ACN) and butadiene), polychloroprene foam (also known as neoprene), polyimide foam, polypropylene (PP) foam (including expanded polypropylene (EPP) and polypropylene paper (PPP)), polystyrene (PS) foam (including expanded polystyrene (EPS), extruded polystyrene foam (XPS) and polystyrene paper (PSP)), styrofoam (including extruded polystyrene foam (XPS) and sometimes expanded polystyrene (EPS)), polyurethane (PU) foam (including LRPu low-resilience polyurethane, memory foam and sorbothane), polyethylene foam, polyvinyl chloride (PVC) foam (including closed-cell PVC foamboard), silicone foam and/or microcellular foam. In one preferred example, the foam comprises and/or is polyurethane foam.

Polyurethane (also known as PUR and PU) is a polymer composed of organic units joined by carbamate (urethane) links. While most polyurethanes are thermosetting polymers, thermoplastic polyurethanes are also available.

Polyurethane polymers are typically formed by reacting a di- or tri poly-isocyanate with a polyol (i.e. the first component and the second component of the polymeric composition, respectively). Since polyurethanes contain two types of monomers, which polymerise one after the other, they are classed as alternating copolymers. Both the isocyanates and polyols used to make polyurethanes contain, on average, two or more functional groups per molecule.

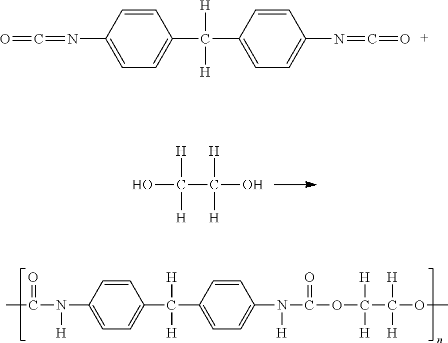

Polyurethane synthesis, wherein the urethane groups —NH—(C═O)—O— link the molecular units. In more detail, polyurethanes are in the class of compounds called reaction polymers, which include epoxies, unsaturated polyesters, and phenolics. Polyurethanes are produced by reacting an isocyanate containing two or more isocyanate groups per molecule (R—(N═C=O)ₙ) with a polyol containing on average two or more hydroxyl groups per molecule (R′—(OH)n[17]) in the presence of a catalyst or by activation with ultraviolet light.

The properties of a polyurethane are greatly influenced by the types of isocyanates and polyols used to make it. Long, flexible segments, contributed by the polyol, give soft, elastic polymer. High amounts of crosslinking give tough or rigid polymers. Long chains and low crosslinking give a polymer that is very stretchy, short chains with lots of crosslinks produce a hard polymer while long chains and intermediate crosslinking give a polymer useful for making foam. The crosslinking present in polyurethanes means that the polymer consists of a three-dimensional network and molecular weight is very high. In some respects a piece of polyurethane can be regarded as one giant molecule. One consequence of this is that typical polyurethanes do not soften or melt when they are heated; they are thermosetting polymers. The choices available for the isocyanates and polyols, in addition to other additives and processing conditions allow polyurethanes to have the very wide range of properties that make them such widely used polymers.

Isocyanates are very reactive materials. This makes them useful in making polymers but also requires special care in handling and use. The aromatic isocyanates, diphenylmethane diisocyanate (MDI) or toluene diisocyanate (TDI) are more reactive than aliphatic isocyanates, such as hexamethylene diisocyanate (HDI) or isophorone diisocyanate (IPDI). Most of the isocyanates are difunctional, that is they have exactly two isocyanate groups per molecule. An important exception to this is polymeric diphenylmethane diisocyanate, which is a mixture of molecules with two, three, and four or more isocyanate groups. In cases like this the material has an average functionality greater than two, commonly 2.7.

Polyols are polymers in their own right and have on average two or more hydroxyl groups per molecule. Polyether polyols are mostly made by co-polymerizing ethylene oxide and propylene oxide with a suitable polyol precursor. Polyester polyols are made similarly to polyester polymers. The polyols used to make polyurethanes are not “pure” compounds since they are often mixtures of similar molecules with different molecular weights and mixtures of molecules that contain different numbers of hydroxyl groups, which is why the “average functionality” is often mentioned. Despite them being complex mixtures, industrial grade polyols have their composition sufficiently well controlled to produce polyurethanes having consistent properties. As mentioned earlier, it is the length of the polyol chain and the functionality that contribute much to the properties of the final polymer. Polyols used to make rigid polyurethanes have molecular weights in the hundreds, while those used to make flexible polyurethanes have molecular weights up to ten thousand or more.

The polymerization reaction makes a polymer containing the urethane linkage, —RNHCOOR′— and is catalyzed by tertiary amines, such as 1,4-diazabicyclo[2.2.2]octane (also called DABCO), and metallic compounds, such as dibutyltin dilaurate or bismuth octanoate. Alternatively, it can be promoted by ultraviolet light. This is often referred to as the gellation reaction or simply gelling.

If water is present in the reaction mixture (it is often added intentionally to make foams), the isocyanate reacts with water to form a urea linkage and carbon dioxide gas and the resulting polymer contains both urethane and urea linkages. This reaction is referred to as the blowing reaction and is catalyzed by tertiary amines like bis-(2-dimethylaminoethyl)ether.

A third reaction, particularly important in making insulating rigid foams is the isocyanate trimerization reaction, which is catalyzed by potassium octoate, for example.

One of the most desirable attributes of polyurethanes is their ability to be turned into foam. Making a foam requires the formation of a gas at the same time as the urethane polymerization (gellation) is occurring. The gas can be carbon dioxide, either generated by reacting isocyanate with water or added as a gas; it can also be produced by boiling volatile liquids. In the latter case heat generated by the polymerization causes the liquids to vaporize. The liquids can be HFC-245fa (1,1,1,3,3-pentafluoropropane) and HFC-134a (1,1,1,2-tetrafluoroethane), and hydrocarbons such as n-pentane.

The balance between gellation and blowing is sensitive to operating parameters including the concentrations of water and catalyst. The reaction to generate carbon dioxide involves water reacting with an isocyanate first forming an unstable carbamic acid, which then decomposes into carbon dioxide and an amine. The amine reacts with more isocyanate to give a substituted urea. Water has a very low molecular weight, so even though the weight percent of water may be small, the molar proportion of water may be high and considerable amounts of urea produced. The urea is not very soluble in the reaction mixture and tends to form separate “hard segment” phases consisting mostly of polyurea. The concentration and organization of these polyurea phases can have a significant impact on the properties of the polyurethane foam.

High-density microcellular foams can be formed without the addition of blowing agents by mechanically frothing or nucleating the polyol component prior to use.

Surfactants are used in polyurethane foams to emulsify the liquid components, regulate cell size, and stabilize the cell structure to prevent collapse and surface defects. Rigid foam surfactants are designed to produce very fine cells and a very high closed cell content. Flexible foam surfactants are designed to stabilize the reaction mass while at the same time maximizing open cell content to prevent the foam from shrinking.

An even more rigid foam can be made with the use of specialty trimerization catalysts which create cyclic structures within the foam matrix, giving a harder, more thermally stable structure, designated as polyisocyanurate foams. Such properties are desired in rigid foam products used in the construction sector.

Foams can be either “closed-cell”, where most of the original bubbles or cells remain intact, or “open-cell”, where the bubbles have broken but the edges of the bubbles are stiff enough to retain their shape. Open-cell foams feel soft and allow air to flow through, so they are comfortable when used in seat cushions or mattresses. Closed-cell rigid foams are used as thermal insulation, for example in refrigerators.

Polyurethanes are conventionally produced by mixing two or more liquid streams (i.e. the first component and the second component of the polymeric composition, respectively). The polyol stream contains catalysts, surfactants, blowing agents and so on. The two components are referred to as a polyurethane system, or simply a system. The isocyanate is commonly referred to in North America as the ‘A-side’ or just the ‘iso’. The blend of polyols and other additives is commonly referred to as the ‘B-side’ or as the ‘poly’. This mixture might also be called a ‘resin’ or ‘resin blend’. In Europe, the meanings for ‘A-side’ and ‘B-side’ are reversed. Resin blend additives may include chain extenders, cross linkers, surfactants, flame retardants, blowing agents, pigments, and fillers. Polyurethane can be made in a variety of densities and hardnesses by varying the isocyanate, polyol or additives.

The first component and the second component of the polymeric composition are blended, using the blending chamber, to provide the precursor of the polymeric composition. The foam is generated, at least in part, by mixing, using the static mixer included in the first deposition nozzle, the precursor.

Method of Controlling a Vehicle

The second aspect provides a method of controlling a vehicle according to the first aspect to deposit a foam comprising a polymeric composition, the method comprising:

blending, using the blending chamber, the first component and the second component of the polymeric composition to provide the precursor of the polymeric composition;

generating the foam, at least in part, by mixing, using the static mixer included in the first deposition nozzle, the precursor; and

depositing the foam, at least in part, via the first deposition nozzle.

The vehicle, the foam, the polymeric composition, the blending chamber, the first component of the polymeric composition, the second component of the polymeric composition, the precursor of the polymeric composition, the foam, the static mixer and/or the first deposition nozzle may be as described with respect to the first aspect.

In one example, the method comprises receiving a first signal transmitted by a first sensor and to controlling the propulsion system and/or the deposition apparatus, based, at least in part, on the received first signal.

In one example, the method comprises moving the vehicle rearwardly or forwardly and depositing the foam, based, at least in part, on the received first signal.

In one example, the method comprises moving the vehicle rearwardly and depositing the foam, based, at least in part, on the received first signal, while the vehicle moves rearwardly. In one example, the method comprises depositing the foam, based, at least in part, on a distance from an obstacle, for example as determined from the received first signal. In one example, the method comprises controlling a rate of deposition of the foam, based, at least in part, on a distance from an obstacle, for example as determined from the received first signal. In one example, the method comprises moving the vehicle forwardly after depositing the foam. In one example, the method comprises repeatedly moving the vehicle and/or depositing the foam.

In one example, the method comprises moving the vehicle forwardly and depositing the foam, based, at least in part, on the received first signal, optionally while the vehicle moves forwardly.

In one example, the method comprises blending, using the blending chamber, the first component and the second component of the polymeric composition to provide the precursor of the polymeric composition without generating, at least in part, the foam.

In one example, the method comprises generating the foam, at least in part, only by mixing, using the static mixer included in the first deposition nozzle, the precursor.

In one example, the method comprises pumping the first component and the second component of the polymeric composition into the blending chamber.

In one example, the method comprises dividing the precursor, for example equally, by the blending chamber, between a set of deposition nozzles including the first deposition nozzle and a second deposition nozzle.

Deposition Apparatus

The third aspect provides a deposition apparatus for depositing a foam comprising a polymeric composition, the deposition apparatus comprising:

a set of reservoirs, including a first reservoir and a second reservoir arranged to receive therein a first component and a second component of the polymeric composition, respectively; optionally a set of pumps, including a first pump and a second pump arranged to pump the first component and the second component from the first reservoir and the second reservoir, respectively;

a blending chamber in fluid communication with the set of reservoirs via a set of inlet passageways, including a first inlet passageway and a second inlet passageway, wherein the blending chamber is arranged to blend the first component and the second component therein to provide a precursor of the polymeric composition; and

a set of deposition nozzles in fluid communication with the blending chamber via a set of outlet passageways including a first outlet passageway, the set of deposition nozzles including a first deposition nozzle comprising a static mixer arranged to mix the precursor to generate the foam, at least in part, therefrom.

In this way, the deposition apparatus may be utilised for other applications, including depositing insulation in buildings, building bridges or pontoons on water, repairing buildings and/or damaged utility pipes and/or military applications.

The deposition apparatus, the foam the polymeric composition, the set of reservoirs, the first reservoir, the second reservoir, the first component of the polymeric composition, the second component of the polymeric composition, the set of pumps, the first pump, the second pump, the blending chamber, the set of inlet passageways, the first inlet passageway, the second inlet passageway, the precursor of the polymeric composition, the set of deposition nozzles, the set of outlet passageways, the first outlet passageway, the first deposition nozzle and/or the static mixer may be as described with respect to the first aspect.

Method of Depositing a Foam

The fourth aspect provides a method of depositing a foam comprising a polymeric composition, the method comprising:

blending, using a blending chamber, a first component and a second component of the polymeric composition to provide a precursor of the polymeric composition;

generating the foam, at least in part, by mixing, using a static mixer included in a first deposition nozzle, the precursor; and

depositing the foam, at least in part, via the first deposition nozzle.

The foam, the polymeric composition, the blending, the blending chamber, the first component of the polymeric composition, the second component of the polymeric composition, the precursor of the polymeric composition, the generating, the foam, the mixing, the static mixer, the first deposition nozzle and/or the depositing the foam may be as described with respect to the first aspect and/or the second aspect.

Use

The fifth aspect provides use of a blending chamber to blend a first component and a second component of a polymeric composition to provide a precursor of the polymeric composition prior to generating a foam, at least in part, from the precursor using a static mixer.

The blending chamber, the first component, the second component, the polymeric composition, the precursor of the polymeric composition, the foam, and/or the static mixer may be as described with respect to the first aspect.

Definitions

Throughout this specification, the term “comprising” or “comprises” means including the component(s) specified but not to the exclusion of the presence of other components. The term “consisting essentially of” or “consists essentially of” means including the components specified but excluding other components except for materials present as impurities, unavoidable materials present as a result of processes used to provide the components, and components added for a purpose other than achieving the technical effect of the invention, such as colourants, and the like. The term “consisting of” or “consists of” means including the components specified but excluding other components. Whenever appropriate, depending upon the context, the use of the term “comprises” or “comprising” may also be taken to include the meaning “consists essentially of” or “consisting essentially of”, and also may also be taken to include the meaning “consists of” or “consisting of”. The optional features set out herein may be used either individually or in combination with each other where appropriate and particularly in the combinations as set out in the accompanying claims. The optional features for each aspect or exemplary embodiment of the invention, as set out herein are also applicable to all other aspects or exemplary embodiments of the invention, where appropriate. In other words, the skilled person reading this specification should consider the optional features for each aspect or exemplary embodiment of the invention as interchangeable and combinable between different aspects and exemplary embodiments.

### BRIEF DESCRIPTION OF THE DRAWINGS

For a better understanding of the invention, and to show how exemplary embodiments of the same may be brought into effect, reference will be made, by way of example only, to the accompanying diagrammatic Figures, in which:

FIG. 1 schematically depicts a vehicle according to an exemplary embodiment;

FIG. 2 schematically depicts a method of depositing a foam according to an exemplary embodiment;

FIG. 3 shows stress-strain curves of polyurethane foams;

FIGS. 4A (front perspective view) and 4B (plan view) are photographs of a part of a vehicle according to an exemplary embodiment;

FIG. 5A schematically depicts a method of controlling the vehicle of FIGS. 4A and 4B according to an exemplary embodiment and FIG. 5B schematically depicts the vehicle, in use, controlled according to the method of FIG. 5A;

FIG. 6A schematically depicts a method of controlling the vehicle of FIGS. 4A and 4B according to an exemplary embodiment and FIG. 6B schematically depicts the vehicle, in use, controlled according to the method of FIG. 6A;

FIGS. 7A (plan view) and 7B (front perspective view) are photographs of the vehicle of FIGS. 4A and 4B, in more detail;

FIG. 8 is a time series of photographs (side elevation view) of the vehicle of FIGS. 4A and 4B, in use;

FIG. 9A is a time series of photographs (side elevation view) of the vehicle of FIGS. 4A and 4B, in use, and FIG. 9A is a time series of photographs (plan view) of the vehicle of FIGS. 4A and 4B, in use;

FIG. 10 is a time series of photographs (side elevation view) of the vehicle of FIGS. 4A and 4B, in use;

FIG. 11A is a CAD perspective view and FIG. 11B is a schematic cross-sectional view of a blending chamber of the deposition apparatus of the vehicle of FIGS. 4A and 4B;

FIG. 12 is a photograph (perspective view) of a deposition nozzle of the deposition apparatus of the vehicle of FIGS. 4A and 4B;

FIG. 13 schematically depicts a method of controlling a vehicle to deposit a foam comprising a polymeric composition according to an exemplary embodiment; and

FIG. 14 schematically depicts a method of depositing a foam comprising a polymeric composition according to an exemplary embodiment.

### DETAILED DESCRIPTION OF THE DRAWINGS

Vehicle

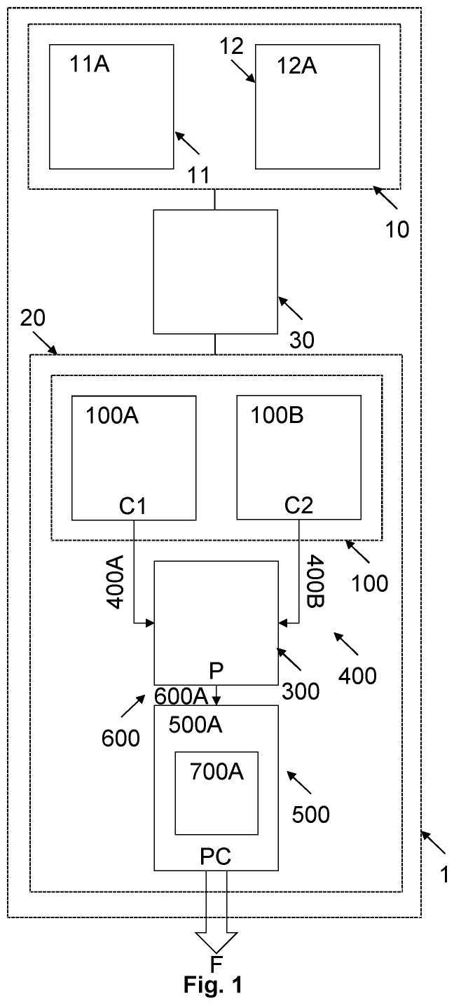

FIG. 1 schematically depicts a vehicle 1 according to an exemplary embodiment. The vehicle 1 is preferably an unmanned and/or autonomous vehicle, for example a robot. The vehicle 1 comprises: a propulsion system 10, arranged to propel the vehicle 1, comprising a set of wheels 11 including a first wheel 11A and/or a set of tracks 12 including a first track 12A; a deposition apparatus 20 for depositing a foam F comprising a polymeric composition PC; and a controller 30 arranged to control the deposition apparatus 20 and optionally, the propulsion system 10. The deposition apparatus 20 comprises a set of reservoirs 100, including a first reservoir 100A and a second reservoir 100B arranged to receive therein a first component C1 and a second component C2 of the polymeric composition PC, respectively; optionally a set of pumps 200 (not shown), including a first pump 200A (not shown) and a second pump 200B (not shown) arranged to pump the first component C1 and the second component C2 from the first reservoir 100A and the second reservoir 100B, respectively; a blending chamber 300 in fluid communication with the set of reservoirs 100 via a set of inlet passageways 400, including a first inlet passageway 400A and a second inlet passageway 400B, wherein the blending chamber 300 is arranged to blend the first component C1 and the second component C2 therein to provide a precursor P of the polymeric composition PC; and a set of deposition nozzles 500 in fluid communication with the blending chamber 300 via a set of outlet passageways 600 including a first outlet passageway 600A, the set of deposition nozzles 500 including a first deposition nozzle 500A comprising a static mixer 700A arranged to mix the precursor P to generate the foam F, at least in part, therefrom.

Example Vehicle

This section describes the design of a foam mixing and depositing device (i.e. a deposition apparatus 20), the characterisation of the foam produced by this device and the integration with an autonomous ground tracked vehicle 2, generally as described with respect to the vehicle 1. Like reference signs denote like features.

In more detail, the vehicle 2 is an autonomous vehicle. The vehicle 2 comprises: a propulsion system 10, arranged to propel the vehicle 1, comprising a set of tracks 12 including a first track 12A and a second track 12B; a deposition apparatus 20 for depositing a foam F comprising a polymeric composition PC; and a controller 30 arranged to control the deposition apparatus 20 and optionally, the propulsion system 10. The deposition apparatus 20 comprises a set of reservoirs 100, including a first reservoir 100A and a second reservoir 100B arranged to receive therein a first component C1 and a second component C2 of the polymeric composition PC, respectively; a set of pumps 200, including a first pump 200A and a second pump 200B arranged to pump the first component C1 and the second component C2 from the first reservoir 100A and the second reservoir 100B, respectively; a blending chamber 300 in fluid communication with the set of reservoirs 100 via a set of inlet passageways 400, including a first inlet passageway 400A and a second inlet passageway 400B, wherein the blending chamber 300 is arranged to blend the first component C1 and the second component C2 therein to provide a precursor P of the polymeric composition PC; and a set of deposition nozzles 500 in fluid communication with the blending chamber 300 via a set of outlet passageways 600 including a first outlet passageway 600A and a second outlet passageway 600B, the set of deposition nozzles 500 including a first deposition nozzle 500A comprising a static mixer 700A and a second deposition nozzle 500B comprising a static mixer 700B arranged to mix the precursor P to generate the foam F, at least in part, therefrom.

In this example, the first deposition nozzle 500A is arranged forwardly of the first track 12A. In this example, the second deposition nozzle 500B is arranged forwardly of the second track 12B. In this example, the first deposition nozzle 500A is arranged aligned with the first track 12A. In this example, the second deposition nozzle 500B is arranged aligned with the second track 12B.

In this example, the propulsion system 10 comprises a set of actuators 13, including a first actuator 13A and a second actuator 13B, arranged to actuate the set of tracks 12, particularly the first track 12A and the second track 12B respectively. In this example, the first actuator 13A and the second actuator 13B are motors, as described below.

In this example, the set of reservoirs 100 includes a third reservoir 100C arranged to receive therein a solvent for cleaning the blending chamber 300, the set of outlet passageways 600 and the set of deposition nozzles 500. In this example, the set of pumps 200 includes a third pump 200C arranged to pump the solvent from the third reservoir 100C and the set of inlet passageways 400 includes a third inlet passageway 400C.

In this example, the vehicle 2 comprises a set of sensors 800 including a first sensor 800A arranged to sense an obstacle O and to transmit a first signal to the controller 30, in response to sensing the obstacle O. In this example, the first sensor 800A is a proximity sensor, particularly an ultrasonic sensor. In this example, the first sensor 800A comprises an array of ultrasonic sensors.

In this example, the controller 30 comprises a processor and a memory and is arranged to control the deposition apparatus 20 and optionally, the propulsion system 10, according to software (i.e. programmatic instructions executed by the processor). In this example, the controller 30 is arranged to receive the first signal transmitted by the first sensor and to control the propulsion system 10 and/or the deposition apparatus 20, based, at least in part, on the received first signal. In this example, the controller 30 is arranged to control the propulsion system 10 to move the vehicle 2 rearwardly or forwardly and to control the deposition apparatus 20 to deposit the foam F, based, at least in part, on the received first signal. In this example, the controller 30 is arranged to control the propulsion system 10 to move the vehicle 2 rearwardly and to control the deposition apparatus 20 to deposit the foam F, based, at least in part, on the received first signal, while the vehicle 2 moves rearwardly. In this example, the controller 30 is arranged to control the deposition apparatus 20 to deposit the foam F, based, at least in part, on a distance from an obstacle O, for example as determined from the received first signal. In this example, the controller 30 is arranged to control a rate of deposition of the foam F by the deposition apparatus 20, based, at least in part, on a distance from an obstacle O, for example as determined from the received first signal. In this example, the controller 30 is arranged to control the propulsion system 10 to move the vehicle 2 forwardly after depositing the foam F. In this example, the controller 30 is arranged to control the propulsion system 10 and/or the deposition apparatus 20 to repeatedly move the vehicle 2 and/or deposit the foam F. In this way, the vehicle 2 may overcome a relatively larger obstacle O. In this example, the controller 30 is arranged to control the propulsion system 10 to move the vehicle 2 forwardly and to control the deposition apparatus 20 to deposit the foam F, based, at least in part, on the received first signal, optionally while the vehicle 2 moves forwardly. In this example, the controller 30 is arranged to control a speed of the set of pumps 200, for example respective speeds of the first pump 200A and the second pump 200B, as a function of time. In this example, the controller 30 is arranged to control a speed of the set of pumps 200, for example respective speeds of the first pump 200A and the second pump independently 200B. In this example, the controller 30 is arranged to calculate a distance from the object O, based, at least in part, on the first signal. In this example, the controller 30 is arranged to calculate a depth and/or a volume of a void, such as a chasm, based, at least in part, on the first signal. In this example, the controller 30 is arranged to calculate an amount of the first component C1 and/or the second component C2 to be deposited as the polymeric composition PC based, at least in part, on the first signal, for example by using the volume of the void to be filled and an expected expansion of the foam F.

Deposition Apparatus

PU is a synthetic resin composed of polymer units linked by urethane groups. The two part constituents must be combined with enough vigour for reaction, upon doing so the mix quickly expands and then sets rigid. Expansion typically occurs within 30-50 seconds and solifidication may take up to 8 minutes. The final mechanical properties of the PU foam are significantly affected by the mix ratio of the two constituent parts, and therefore can be tuned with relative ease. Compressive strengths of over 2 MPa are possible, so that the solidified foam can easily support the weight of a human standing on it. Expansion ratios of over 30× the original volume are viable, meaning that 25 dm³ of solidified foam can be generated from just 0.84 dm³ of the two part liquid constituents. These values depend largely on the mixing style and have been recorded through testing on the proposed system, as discussed below. The foam in its final state is closed-cell, water-proof and lighter than water yet, as mentioned, still strong enough to support the weight of a human climbing thereon. Additionally, these foams adhere to a wide variety of materials including wood, iron, and concrete, among others. Based on these characteristics, this material is suitable for use in disaster scenarios in real-time.

The foam was generated from POLYCRAFT PU5800 (available from MBFibreglass, UK), provided as a two-part pack comprising POLYCRAFT PU5800 PART A and POLYCRAFT PU5800 PART (i.e. the first component C1 and the second component C2 of the polymeric composition PC, respectively). POLYCRAFT PU5800 PART A comprises DIPROPYLENE GLYCOL (CAS 110-98-5) 1-25% and N,N,N′,N′-TETRAMETHYL-2,2′-OXYBIS(ETHYLAMINE) (CAS 3033-62-3) 0.05-1% by volume. POLYCRAFT PU5800 PART A comprises DIPHENYLMETHANE DIISOCYANATE (ISOMERS AND HOMOLOGUES) (CAS 9016-87-9).

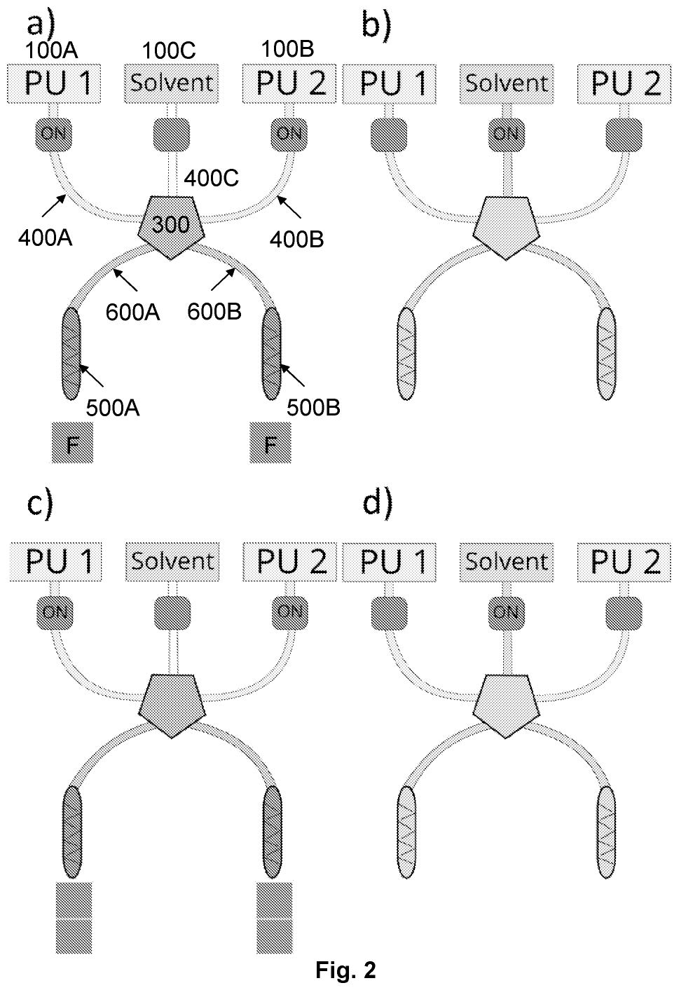

Peristaltic pumps (i.e. the first pump 200A and the second pump 200B) (9QX Peristaltic Pump 24V 3 Roller Stepper Motor available from Boxer GmbH, Germany) are used to drive PU part one and two (i.e. part A and part B) from their separate reservoirs (i.e. the first reservoir 100A and the second reservoir 100B, respectively) to the blending chamber 300 via respective inlet passageways (i.e. the first inlet passageway 400A and the second inlet passageway 400B) (Tubing type: PHI 3.5×5.6 mm, 1.05 mm wall available from Boxer GmbH, Germany). This blending chamber 300 ensures the two parts have been thoroughly mixed without increasing the turbulence to such an extent that the parts begin reacting. This mixing is necessary as multiple outlets may be required, and the viscous nature of the individual parts would otherwise make them flow without mixing. The now combined PU (i.e. the precursor P) is split across different channels (i.e. the first outlet passageway 600A and the second outlet passageway 600B) and passed through static mixing nozzles (MA6.3-21S, Adhesive Dispensing Ltd, UK) before being ejected at the outlets (i.e. the first deposition nozzle 500A and the second deposition nozzle 500B). A major drawback of conventional apparatuses is the blockage that occurs between uses, and even during use. This happens as residues, if not treated, will be left in the system and particularly in the static mixing nozzles. As the parts begin to react they become very adhering and as they expand often cause channels to become completely blocked. For the system, a solvent (isopropyl alcohol), driven by a third peristaltic pump (i.e. the third pump 200C) (9QX Peristaltic Pump—DC/Gear Motor 520 rpm 12V-3 roller available from Boxer GmbH, Germany), is then autonomously flushed through the set of inlet passageways 400, the blending chamber 300, the set of outlet passageways 600 and the set of deposition nozzles 500 at the end of each depositing phase to stop the reaction and eject any residue. This allows the deposition apparatus 20 to be used multiple times without blockage or manual intervention. The whole process is illustrated in FIG. 2.

In more detail, FIG. 2 illustrates the stages of pumping PU part one and two to create PU foam and the solvent flush stages: a) pumping of PU part one and two to create first batch of PU foam; b) flush of solvent to ensure no blockages after use; c) pumping of PU part one and two to create second batch of PU foam; d) flush of solvent. Peristaltic pumps are represented by red symbols, central pentagon represents the mixing chamber and crossed cylinder represent the static mixing nozzles.

Driving the system with independent peristaltic pumps produces several advantages over current systems. Firstly, the amount of liquid being driven at any point is equal to the volume inside the tubing and mixing devices, and is thus independent of the size of the reservoir from which it is being pumped. This implies that the flow generated by the pump is not affected by the size of the reservoirs, unlike conventional deposition apparatuses, and therefore the system can be significantly scaled without redesign, allowing large amount of material deposition.

Furthermore, the system can control the flow rate of each pump independently so that the ratio between PU Part one and Part two can be easily controlled. Such ratio controls the properties of the solidified foam, as previously mentioned. For example, if the system required a harder deposit, it could autonomously increase the ratio of PU Part one to the mix. Likewise, increasing the ratio of PU Part two would increase expansion ratio; this could be necessary if maximising the volumetric output was required. Additionally, increasing overall flow velocity increases the turbulence during the mixing of chemicals, thus reducing the time taken to begin expansion. This has the potential to allow the deposited material to be less fluid-like and immediately sticky, with obvious applications for foam deposition on vertical surfaces or gradients. Alternatively, making the deposited material more liquid-like on exit allows deposition into crevices and cracks for structural stabilisation. These options would not be possible for current state of the art syringe or aerosol depositing systems. However, increasing the rate of reaction above a certain level makes the substance more likely to block the static-mixers and thus a maximum overall pump speed is set to prevent this. Finally, the system allows the pumps to drive the liquids to two outlets, although it is possible to increase this number.

Foam Characterisation

Four different PU foams obtained via the proposed depositing device are characterised in this section in terms of their most relevant properties: mix ratio, expansion ratio, initial compressive strength, final compressive strength, rise time and set time. Note that the values reported for these four PU foams do not represent the upper and lower limits for properties such as compressive strength and expansion ratio. However, mixes that result in higher expansion ratios result in compressive strengths that may be too low for the deposit to be considered useful for structural applications but may be useful for insulation or buoyancy, for example. Conversely, mixes that result in lower expansion ratios result in compressive strengths that may be sufficient for the deposit to be considered useful for structural applications but may be less useful or non-economic for insulation or buoyancy, for example. In other words, a desired ratio may be selected for a particular application, to balance mechanical properties such as compressive strength, physical properties such as density, thermal properties such as thermal conductivity, curing time and/or cost.

Mix ratio considers the volumetric ratio between PU foam Part one and Part two, and it is controlled via the pump rates of the peristaltic pumps. Expansion ratios were measured by depositing the PU foam into a container and comparing the initial height of the deposited foam, with the final height of the deposited foam after the expansion had occurred. This method provides conservative estimates of expansion ratios as deposition in free space (e.g. on a surface exposed to air) allows more oxidation to occur, and therefore more expansion. However, depositing on a free surface would make it impossible to have consistency due to the different shapes assumed by the deposit.

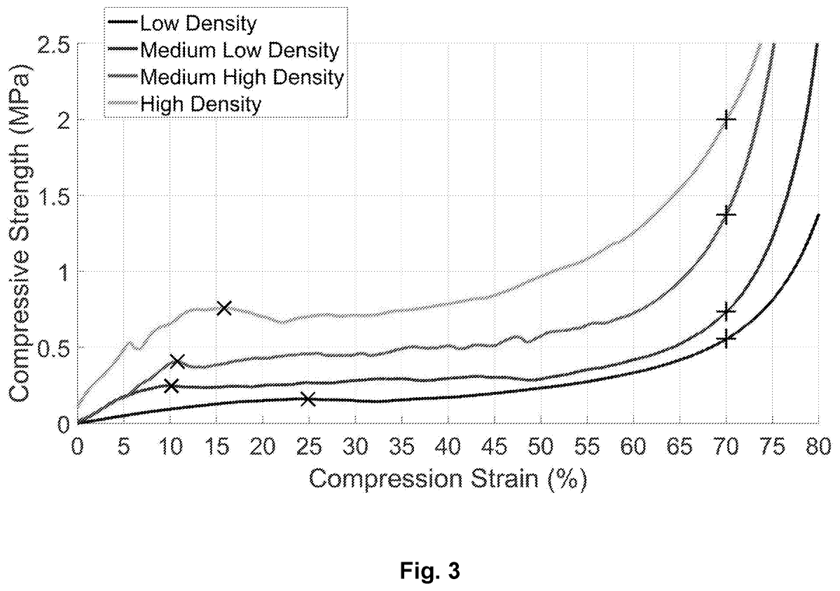

Typically, maximum compressive strength considers the amount of force applied per unit area until a material fails, where failure is often defined by the material cracking. However, PU foam, unlikely many solid materials, will continue to deform with sufficient pressure without breakage. Therefore, two alternative definitions of compressive strength are used here: initial compressive strength and final compressive strength. The former is defined as the pressure applied before permanent plastic deformation occurs, and is highlighted with the symbol ‘X’ in FIG. 3. FIG. 3 shows stress-strain curves of the foam for different mix ratios, see also Table 2. Final compressive strength is defined as the pressure at which the height of the deposit is reduced by 70%, as shown in FIG. 3 with the symbol ‘+’ Beyond this point the deposit is considered useless for overcoming obstacles.

Rise time is measured from initial deposition until final expansion has occurred. Finally, set time is measured from initial deposition until the foam has fully solidified, this is done by comparing stiffness until it is deemed the material is no longer solidifying and the material is immediately tested in the Instron machine (INSTRON 3345) loading the specimens at 2 mm/min. More importantly than the absolute values of the properties measured for the different PU foams are their relative differences, as they prove that the proposed deposit system can easily control the properties of the deposited material. A summary of properties of the deposited foams are reported in Table 2, where each foam is defined by the mix ratio of Part one to Part two.

TABLE 2
Characterisation of four types of PU foam

| | | Medium- | Medium- | |
|---|---|---|---|---|
| | Low | Low | High | High |
| | Density | Density | Density | Density |
| Mix Ratio (one:two) | 1:0.74 | 1:1 | 1:1.4 | 1:1.6 |
| Expansion Ratio | 33x | 29x | 25x | 2x |
| Initial Compressive | 0:16M | 0:25 | 0:41 | 0:76 |
| Strength (MPa) | | | | |
| Final Compressive | 0.56 | 0.74 | 1:37 | 2 |
| Strength (MPa) | | | | |
| Rise Time (s) | 37 | 46 | 52 | 55 |
| Set Time (s) | 210-270 | 240-300 | 270-340 | 310-380 |

Robotic Platform

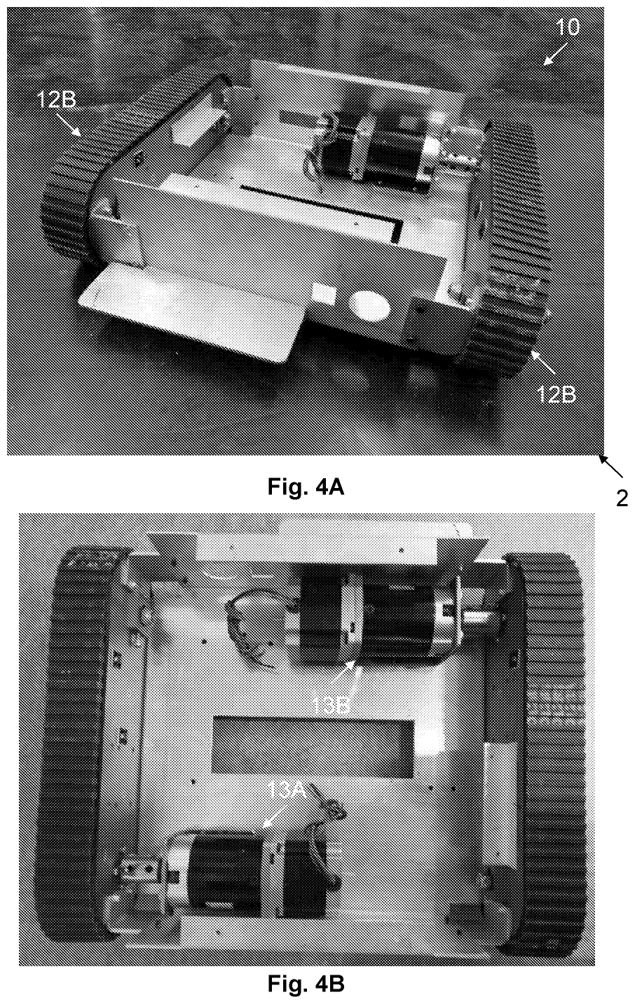

The PU depositing system has the potential to be combined with any existing robotic platform to extend its ability. For the purposes of testing, the simple low cost ground rover (i.e. the vehicle 2) shown in FIGS. 4A and 4B was used.

This platform is a two-tracked vehicle with a track height of 100 mm and a track length of 300 mm. The rover has a pressure value of 0.02 MPa (15 kg rover on the total surface area of its tracks), making any of the earlier defined foams suitable for the platform. The platform is driven by two large stepper motors (RB-Phi-266, Robotshop), which would allow a 50 kg payload to be pulled along an even medium friction surface. The rover is driven by a central Arduino Mega 2560 board (i.e. the controller 30) which controls the motor speeds via two Arduino Nano boards and the pumping systems via another Arduino Mega 2560. A digital compass is connected to the central control board to feed orientation information back to the controller and positional information is calculated from the localisation system, as described below. The PU foam depositing system was mounted on top of the rover with the two outlets positioned directly behind the tracks. As the rover moves, the foam will be deposited, forming two distinct extrusions which are aligned with the rovers tracks. Once the foam has expanded and solidified, the rover can simply climb on said extrusions to increase or maintain altitude. When depositing foam in a straight line, controlling either deposit speed or rover speed allows the platform to create ramp structures, as described below.

Experimental Setup

Two main experiments are designed to demonstrate the effectiveness of the proposed PU foam depositing system: obstacle climbing and chasm traversing.

Sensing and Depositing Strategies

Ultrasonic distance sensors (HC-SR04) are utilised to determine the presence of obstacles or chasms in front of the vehicle. If an object is detected, a ramp construction procedure is initiated, whereas a void filling function is executed if a chasm is present.

Frontal Object Detection

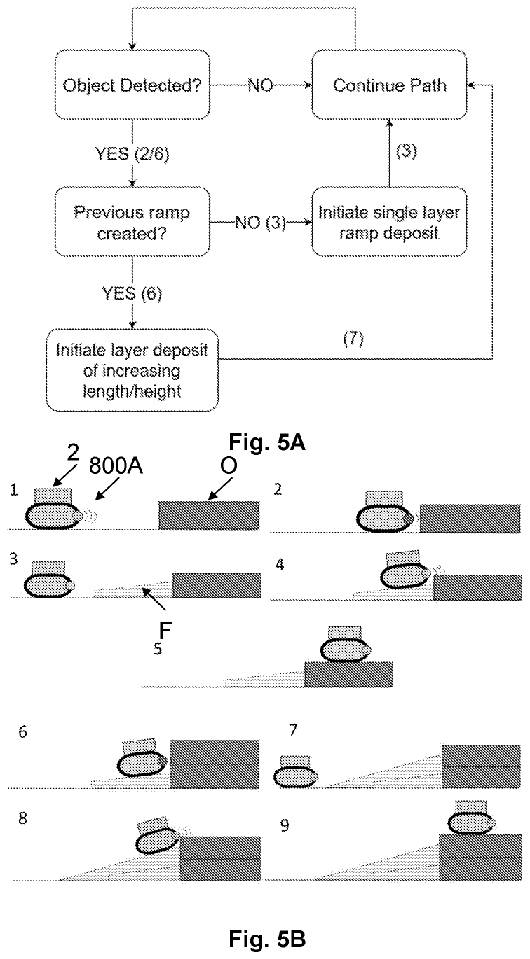

One sensor is placed at the front of the rover, at just above half of the rover track height. It was determined through testing that if an object is detected at this height or above, the rover will not be able to overcome it independently. As the rover cannot sense if the object is perpendicular to its path, once the object is detected, the rover will begin to move forward at a low motor torque to align the rover front face with the straight edge of an object upon contact. Once the frontal face of the rover has been aligned with the object, the depositing protocol will begin. For this, predetermined deposit rate/time sequence is initiated that will produce a ramp that allows the rover to overcome an obstacle at half of the rover track height. Testing was done to determine the maximum ramp angle for the rover, the deposit sequence ensures that the angle of the ramp is well below this threshold. Delays are also preset to ensure full foam set and curing time. If an obstacle is detected after climbing on this deposit, then the same procedure will be repeated, but with increased ramp length, thus ensuring angle of ramp below maximum ramp angle. The rover can overcome minor over/under expansions for frontal obstacles that may occur. The ramp building protocol, described in the flowchart of FIGS. 5A and 5B is then initiated, giving rise to the responses illustrated in the same figure. FIG. 5A Flowchart and FIG. 5B are illustrations of the frontal object detection system and ramp building

Chasm Detection

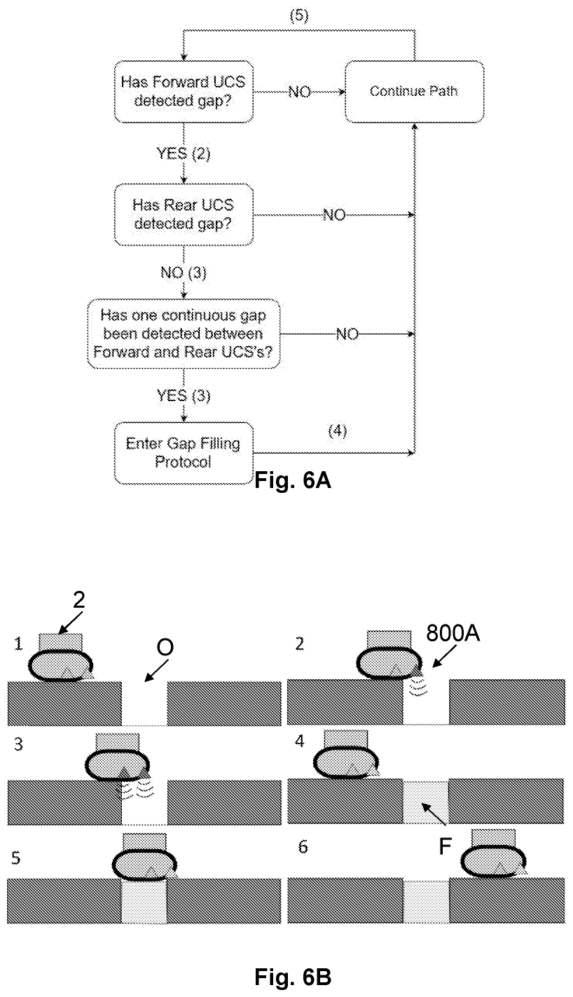

The chasm detection scenario considers detecting large gaps in the floor preventing path following. The rover used for testing can overcome chasms of up to 100 mm (one third of the total length) without falling into said gap, but longer gaps would prevent its motion. To address this challenge, two sensors are placed on the undercarriage of the chassis, facing the ground: one is positioned at the front of the rover and other at around one third of the rover length from the front. If both forward and centre undercarriage sensors detect a continuous gap, the rover will stop moving and initiate a void filling procedure. At first, the rover uses depth measurements of the chasm to estimates the amount of deposit required. However, if it under deposited (for example if the chasm was not uniform and larger than expected) then it would once again detect the chasm and repeat the filling procedure. Over-depositing typically leads to foam overflowing the chasm, but the extra amount is usually trivial for the rover to overcome. A flowchart of autonomous response to chasms and respective illustration for the responses are shown in FIGS. 6A and 6B. Chasm detection is overridden when climbing a ramp produced by the system.

Localisation Platform

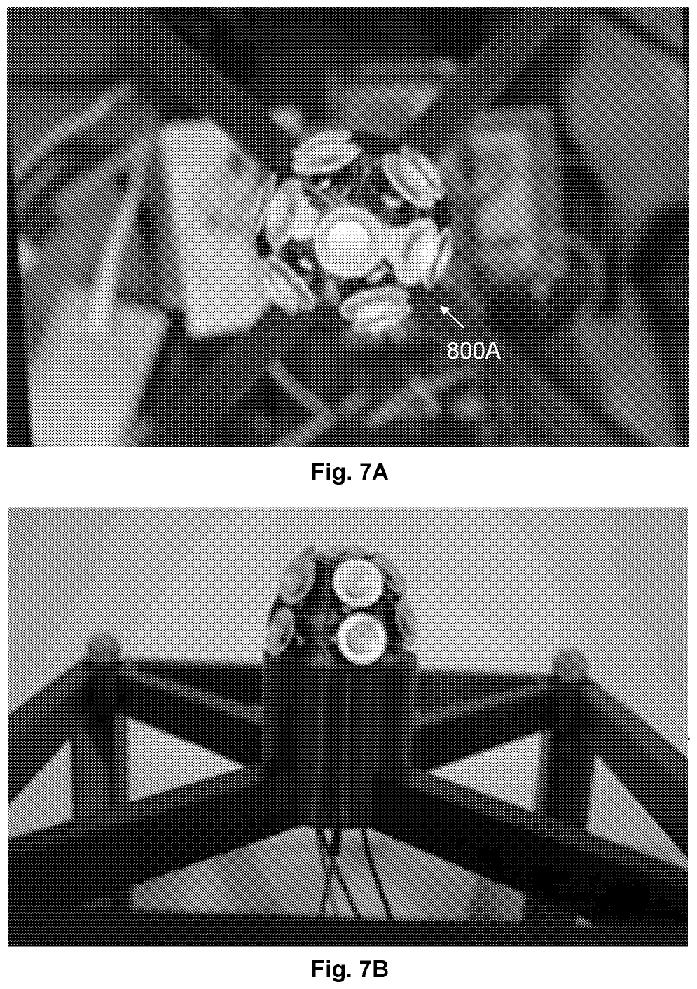

During the experimental tests the rover is tasked with following a desired path within a 4.3 m by 3.1 m arena and the obstacle avoidance protocols described above activate if said path is being blocked. To perform path following, a low-cost localisation system based on ultrasonic sensing and time difference of arrival was designed. The compact ultrasound emitter shown in FIGS. 7A and 7B was designed to generate omnidirectional train of ultrasound pulses which are then picked up by several fixed receivers measuring the time difference of arrival. A least squares approach is used to analytically obtain a first estimate of the emitter position, which is then refined through steepest descent optimisation. All processing is done via a standard Arduino platform, proving the low computational demands of the method. Localisation results have been validated against a state-of-the-art Optitrack motion capture system composed of 8 Prime17W cameras, to validate onboard determination of the rover, using the onboard ultrasound localisation system, against the external motion capture system. The ultrasound localisation system allows estimation of rover position within an accuracy of better than 3 cm over 89% of arena and better than 1 cm over 43% of the arena. Overall, the mean localisation error is 1.57 cm and the average standard deviation is 1.39 cm throughout the arena, making it suitable for being embedded on the mobile robotic platform used for the experiments. Three experiments were carried out with both detection systems being operational. The rover is given a straight line path to follow, but if any object is detected along this path the vehicle must work out how best to overcome it. All three experiments require the ability to: i) detect an obstacle that prevents the rover from following the planned path ii) eject the PU foam correctly iii) flush the system to ensure no blockages occur iv) wait until the foam has cured and then overcome obstacle using the deposited foam. The first two experiments consider frontal obstacles and the third considers chasm detection. For all three tests the mix ratio of PU Part one:Part two was fixed at 1:1 (Medium-Low Density foam) so that it can settle within 6 minutes, expand around 29× and have sufficient strength to support the rover weight. All three of these obstacles have been tested to ensure that the rover could not overcome them without using the PU depositing system: with the rover toppling/not able to grip onto the material for the frontal objects or getting stuck in the chasm. Total run time is taken from the moment the object is detected until the time the object has been fully overcome (the entire rover is atop the object or passed the chasm).

Small Frontal Object Test

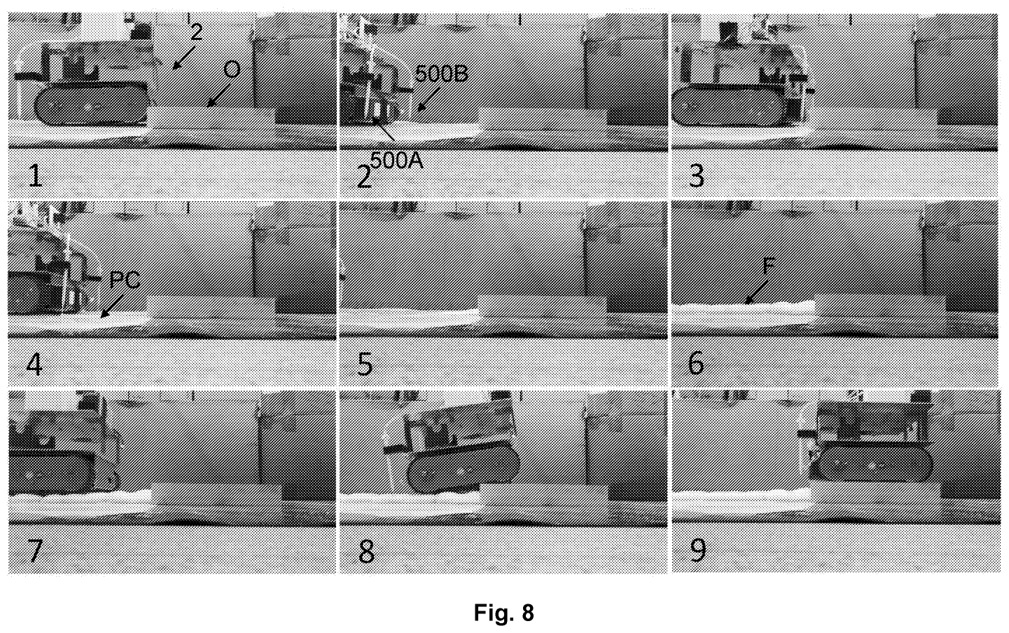

In the first experiment, a 60 mm high block—60% of the 100 mm rover height—was placed along the desired path. The rover detected the object, aligned itself and began the ramp deposit procedure. The vehicle created the ramp by varying pump speed as it moved away at a constant speed so that more material was deposited closer to the object, as shown in FIG. 8. The platform then waited for the foam to expand and solidify before using the deposit to continue its path. No further obstacle was detected and the rover could successfully climb onto the object. The total time to run this experiment was 6 minutes and 42 seconds.

FIG. 8.1: The vehicle 2 approaches the obstacle O (i.e. the 60 mm high block).

FIG. 8.2: The vehicle 2 moves away from the obstacle O and turns around, such that the set of deposition nozzles 500 face the object O.

FIG. 8.3: The vehicle 2 moves towards the obstacle O, senses the obstacle O and stops.

FIG. 8.4: The vehicle 2 moves rearwardly while depositing the PU foam F as two lines, the rate of depositing decreasing as the vehicle 2 moves further away from the obstacle O.

FIG. 8.5: The deposited PU foams to provide the foam F.

FIG. 8.6: The deposited PU continues to foam, defining a ramp, and cures.

FIG. 8.7: The vehicle 2 climbs the ramp and moves towards the obstacle O.

FIG. 8.8: The vehicle 2 climbs from the ramp onto the obstacle O.

FIG. 8.9: The vehicle 2 is fully on the obstacle O.

Large Frontal Object Test

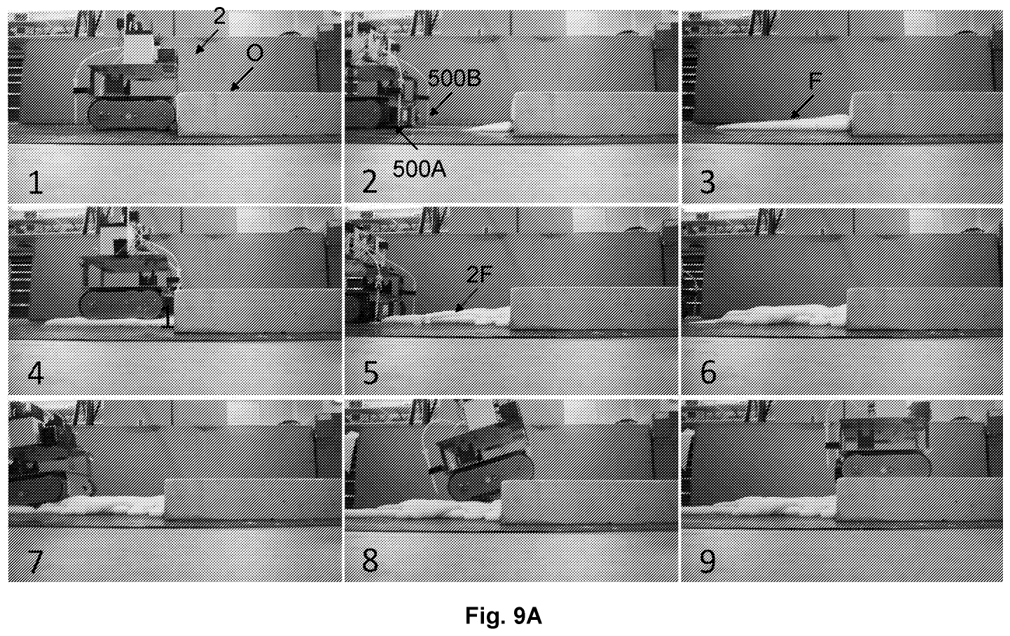

In the second experiment, a 130 mm high block—130% times the rover height—was placed along the planned path. The rover detected the object and conducted the same first layer ramp deposit procedure as in the previous experiment. However, upon climbing the ramp it detects the object again. Knowing it has previously deposited a ramp, the rover initiates the ramping procedure but deposits foam for an increased distance compared to the previously created ramps. The platform then waited for the second layer to cure and was able to overcome the object, as shown in FIGS. 9A and 9B. The success of this test proves that building large, multi-layered ramp structures is possible and that the system ensures no blockages occur between layers/uses. Total time for this experiment was 13 minutes and 42 seconds.

FIG. 9A.1 and FIG. 9B.1: The vehicle 2 approaches the obstacle O (i.e. the 120 mm high block).

FIG. 9A.2 and FIG. 9B.2: The vehicle 2 moves towards the obstacle O, senses the obstacle O and stops. The vehicle 2 moves rearwardly while depositing the PU foam F as two lines, the rate of depositing decreasing as the vehicle 2 moves further away from the obstacle O.

FIG. 9A.3 and FIG. 9B.3: The deposited PU foams to provide the foam F. The deposited PU continues to foam, defining a ramp, and cures.

FIG. 9A.4 and FIG. 9B.4: The vehicle 2 climbs the ramp, moves towards the obstacle, senses the obstacle O and stops.

FIG. 9A.5 and FIG. 9B.5: The vehicle 2 moves rearwardly while depositing a second layer of PU foam F2 as two lines on top of the previously-deposited foam F, the rate of depositing decreasing as the vehicle 2 moves further away from the obstacle O, repeating steps 9.2-9.4 for longer time/distance to create a longer ramp.

FIG. 9A.6 and FIG. 9B.6: The deposited PU foams to provide the foam F2. The deposited PU continues to foam, defining a higher ramp, and cures.

FIG. 9A.7 and FIG. 9B.7: The vehicle 2 climbs the ramp and moves towards the obstacle O.

FIG. 9A.8 and FIG. 9B.8: The vehicle 2 climbs from the ramp onto the obstacle O.

FIG. 9A.9 and FIG. 9B.9: The vehicle 2 is fully on the obstacle O.

Chasm Test

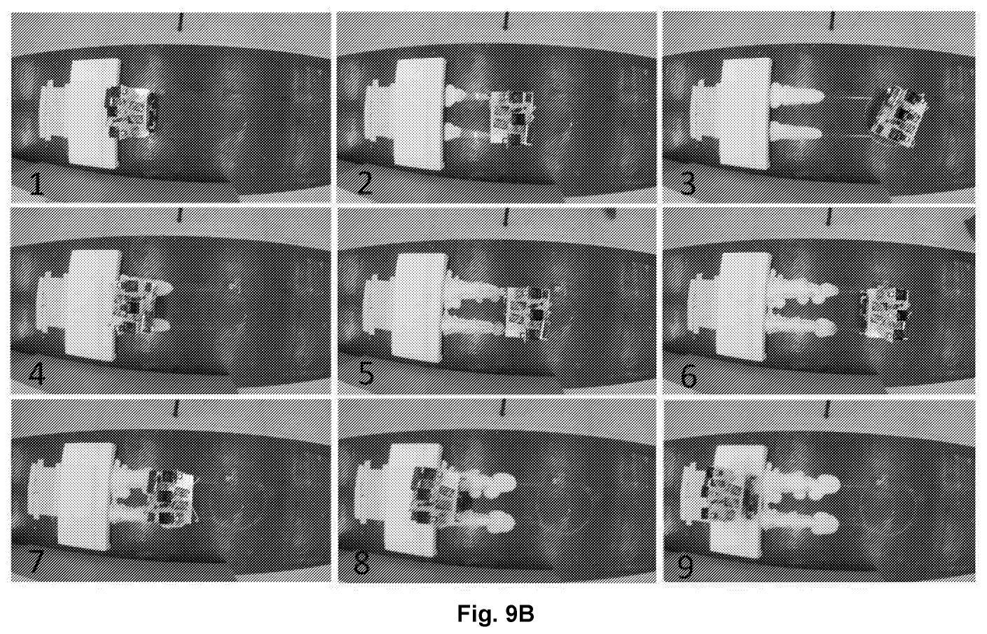

In the final experiment a 160 mm long chasm was placed along the rover's path, over half the 300 mm rover tracks length. The chasm was 80 mm deep and 400 mm wide. When the rover detected a small gap with the frontal undercarriage sensor, it reduced its speed to ensure it had sufficient time to either detect whether it was able or not to overcome the chasm without depositing material. Once the rover detected that the chasm was too long by using both undercarriage sensors, it started its gap filling procedure. The material depositing system estimated the amount of material to be deposited from the knowledge of the depth of the chasm (measured by sensors), performed the deposit and then waited for this to expand and solidify. The rover successfully filled the chasm and traversed the gap as shown in FIG. 10.

Total time for this experiment time was 5 minutes and 50 seconds.

FIG. 10.1: The vehicle 2 approaches the obstacle O (i.e. the chasm), senses the obstacle O and stops.

FIG. 10.2: The vehicle 2 moves away from the obstacle O and turns around, such that the set of deposition nozzles 500 face the object O.

FIG. 10.3: The vehicle 2 deposits the PU foam F into the obstacle O.

FIG. 10.4: The deposited PU foams, filling the chasm, and cures.

FIG. 10.5: The vehicle 2 moves over the foam F, traversing the obstacle O.

FIG. 10.6: The vehicle 2 has traversed the obstacle O.

Blending Chamber

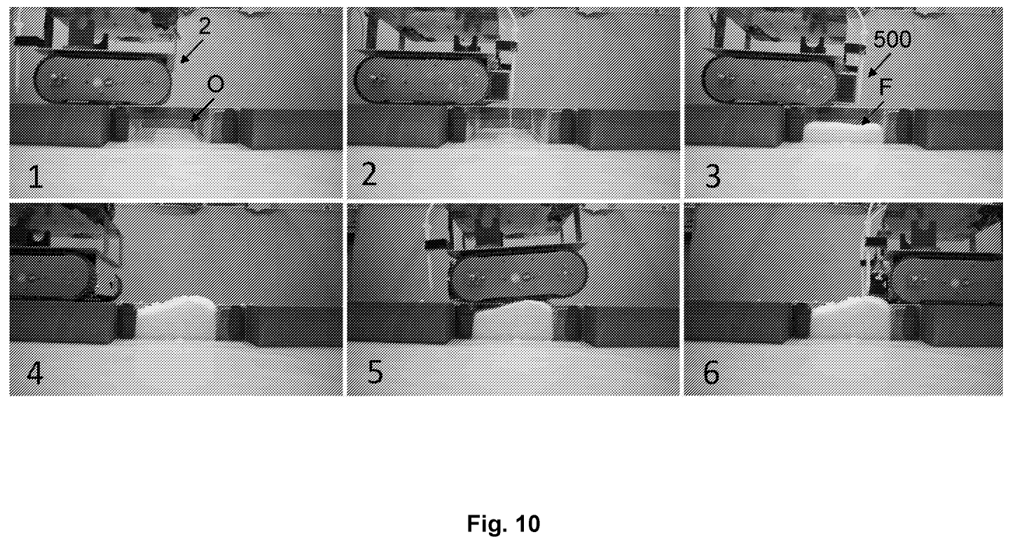

FIG. 11A is a CAD perspective view and FIG. 11B is a schematic cross-sectional view of a blending chamber 300 of the deposition apparatus 20 of the vehicle 2 of FIGS. 4A and 4B. In this example, the blending chamber 20 comprises a set of spherical chambers 310, including a first chamber 310A and a second chamber 310B , both having internal radii of 6 mm, for example a pair thereof of mutually interconnecting chambers, particularly indirectly interconnecting via an interconnecting passageway 320. In this example, the set of inlet passageways 400 (400A, 400B, 400C) have an internal diameter of 2 mm and are fluidically coupled to the first chamber 310A. In this example, the set of outlet passageways 600 (600A, 600B) have an internal diameter of 2 mm and are fluidically coupled to the second chamber 310B. In this example, the interconnecting passageway 320 has an internal diameter of 4 mm, smaller than a diameter of the first chamber 310A and the second chamber 310B. In this example, the blending chamber 20 does not comprise a static mixer, for example a helical static mixer or a plate-type static mixer. In this example, the blending chamber 20 comprises smooth internal walls, without any protuberances therefrom.

Deposition Nozzle

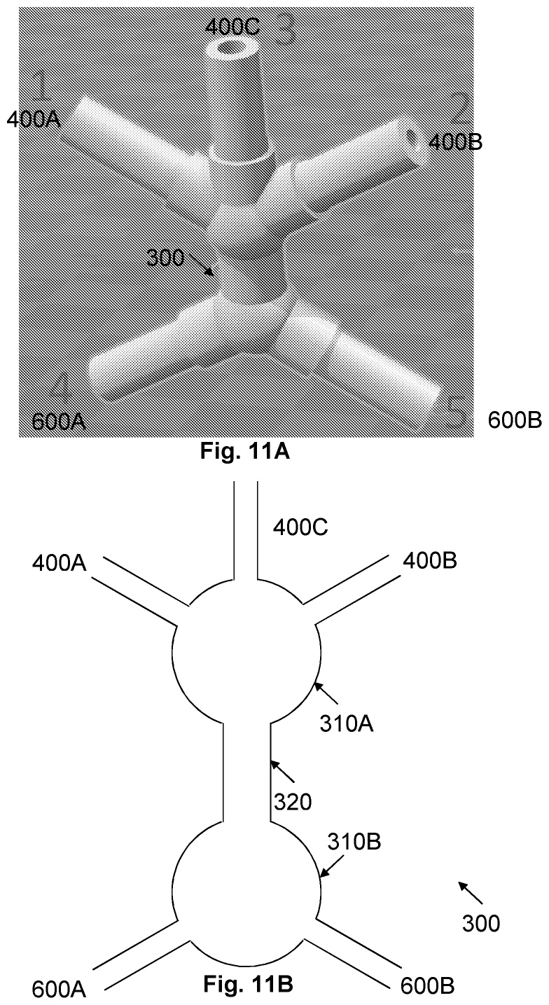

FIG. 12 is a photograph (perspective view) of a deposition nozzle of the deposition apparatus of the vehicle of FIGS. 4A and 4B. The deposition nozzle is a static mixing nozzle (MA6.3-21S, Adhesive Dispensing Ltd, UK). In more detail, the deposition nozzle is a bayonet inlet, helical static mixer nozzle, conventionally for 50 ml and 75 ml dual component cartridges. Stepped outlet that can be cut back to increase orifice size and increase flow rates. These mixer nozzles are suitable for all two-component materials. They have white elements and are constructed of high grade polypropylene. High quality mixer nozzles for use with twin cartridges. 6.3 mm ID×21 mixing elements. Use with 50 ml 1:1 and 2:1 ratio bayonet style dual cartridges. Part ID: MA6.3-215. Material: Polypropylene. Colour: Natural Outer, White Elements. Inner Diameter: 6.3 mm. Outer Diameter: 9 mm. Length: 153 mm. Tip Outlet: 1.5 mm. Elements: 21. Retained Volume: 3.6 ml. Details: Industrial grade, Silicone Free.

Summary of Experimental Results

A summary of the experimental results is reported in Table 3, showing that the proposed PU foam depositing system enables the rover to overcome obstacles which were previously insurmountable. In all cases, the volumetric expansion ratio was between 29× and 32×, showing the robust control over the mixing process and, hence, the final mechanical properties of the foam. These values also prove that conservative estimates were attained during characterisation for expansion, this was ascertained to be due to free rise expansion being larger than controlled expansion in a measuring beaker. Survival rates of trapped victims within collapsed buildings depends entirely on the circumstance, with major trauma and suffocation typically killing within hours. A depositing system that can enable a robotic platform to access these areas within minutes is suitable.

TABLE 3
Summary of experimental results, where H = Height,
D = Depth, L = Length and Vol = Volume.

| | Test One | Test Two | Test Three |
|---|---|---|---|
| Type | Small Frontal | Large Frontal | Chasm |
| Dimensions | H: 60 | H:130 | D × L: 100 × 200 |
| (mm) | | | |
| Deposit Vol | 2000 | 5000 | 4000 |
| (cm³) | | | |
| PU used | 63 | 170 | 126 |
| Run time | 6 mins 42 secs | 13 mins 42 secs | 5 mins 50 secs |

Method of Controlling a Vehicle

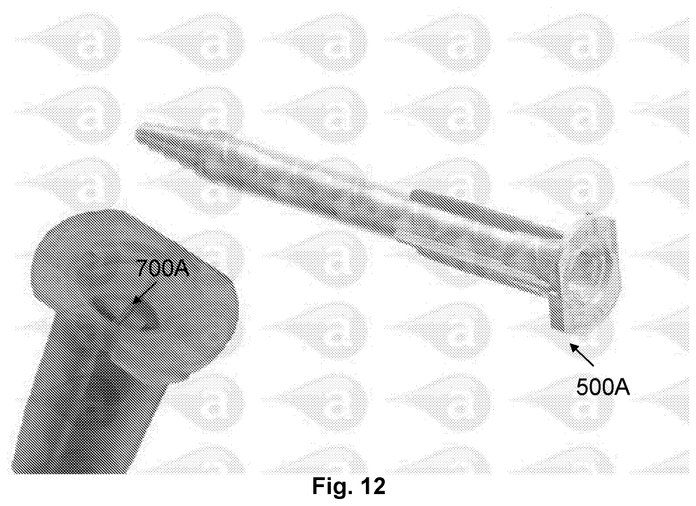

FIG. 13 schematically depicts a method of controlling a vehicle to deposit a foam comprising a polymeric composition according to an exemplary embodiment; and

At S1301, a first component and a second component of the polymeric composition are blended, using a blending chamber, to provide a precursor of the polymeric composition.

At S1302, the foam is generated, at least in part, by mixing, using a static mixer included in a first deposition nozzle, the precursor.

At S1303, the foam is deposited, at least in part, via the first deposition nozzle. The method may comprise any of the steps described herein.

Method of Depositing a Foam

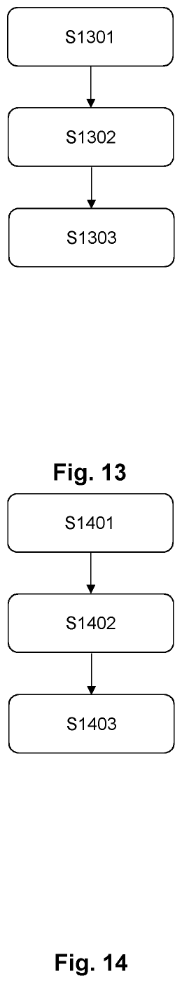

FIG. 14 schematically depicts a method of depositing a foam comprising a polymeric composition according to an exemplary embodiment.

At S1401, a first component and a second component of the polymeric composition are blended, using a blending chamber, to provide a precursor of the polymeric composition.

At S1402, the foam is generated, at least in part, by mixing, using a static mixer included in a first deposition nozzle, the precursor.

At S1403, the foam is deposited, at least in part, via the first deposition nozzle.

The method may comprise any of the steps described herein.

Although a preferred embodiment has been shown and described, it will be appreciated by those skilled in the art that various changes and modifications might be made without departing from the scope of the invention, as defined in the appended claims and as described above. For example, while the deposition apparatus is described included in the vehicle, the skilled person would understand that the deposition apparatus may be provided separately from the vehicle and/or the controller.

### SUMMARY

In summary, the invention provides a vehicle, a method of controlling a vehicle, an apparatus for depositing a foam, a method of depositing a foam and use of a blending chamber.

One of the most difficult challenges faced by ground robots operating in the aftermath of a disaster is the presence of uneven and unstable terrains; in these environments traditional locomotive systems struggle. In this work, a polyurethane foam depositing system is proposed to enable ground robots to overcome obstacles and navigate challenging substrates with relative ease. The proposed system is inexpensive, can be added onto existing platforms and enables autonomy via simple control systems. The final mechanical properties of the foam can be tuned in real-time and on board to adapt to different situational requirements. Four deposit foam types have been fully characterized, with volumetric expansion ratios ranging from 20× to 33×, compressive strengths from 0.16 MPa to 2 MPa and full expansion and set times below 6 minutes in all cases. To show that real-time operations are possible, the system has been implemented on a two-tracked rover which was then able to accurately control the amount of deposited foam to form structures such as single and multilayered ramps and blocks. Thanks to this, the vehicle was able to autonomously overcome large objects and chasms that would have otherwise prevented operation.

In more detail, an inexpensive and easy-to-use apparatus for depositing a foam is described. The apparatus is designed as an independent module for existing robotic platforms to expand their capabilities. Thanks to its design, the apparatus can be utilised without complicated control algorithms to allow ground vehicles to autonomously overcome obstacles. This allows complete control over the deposited material: the PU foams expansion ratio and final compressive strength can be tuned autonomously according to the situational requirement. The integrated solvent flush system allows the long term use of the apparatus without blockage, a typical drawback of existing platforms. Initial tests show that the vehicle provides a significant improvement of the capability of ground vehicles to move on uneven terrains. The apparatus then removes the main obstacle for using ground robots in disaster scenarios.

Notes

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims and drawings), and/or all of the steps of any method or process so disclosed, may be combined in any combination, except combinations where at most some of such features and/or steps are mutually exclusive.

Each feature disclosed in this specification (including any accompanying claims, and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims and drawings), or to any novel one, or any novel combination, of the steps of any method or process so disclosed.

1. A vehicle comprising:
a propulsion system, arranged to propel the vehicle, comprising a set of wheels including a first wheel and/or a set of tracks including a first track;
a deposition apparatus for depositing a foam comprising a polymeric composition; and
a controller arranged to control the deposition apparatus or the deposition apparatus and the propulsion system;
wherein the deposition apparatus comprises:
a set of reservoirs, including a first reservoir and a second reservoir arranged to receive therein a first component and a second component of the polymeric composition, respectively;
a set of pumps, including a first pump and a second pump arranged to pump the first component and the second component from the first reservoir and the second reservoir, respectively;
a blending chamber in fluid communication with the set of reservoirs via a set of inlet passageways, including a first inlet passageway and a second inlet passageway, wherein the blending chamber is arranged to blend the first component and the second component therein to provide a precursor of the polymeric composition; and
a set of deposition nozzles in fluid communication with the blending chamber via a set of outlet passageways including a first outlet passageway, the set of deposition nozzles including a first deposition nozzle comprising a static mixer arranged to mix the precursor to generate the foam, at least in part, therefrom.

2. The vehicle according to claim 1, wherein the set of deposition nozzles includes a second deposition nozzle in fluid communication with the blending chamber via a second outlet passageway of the set of outlet passageways.

3. The vehicle according to claim 1 any previous claim:
wherein the set of reservoirs includes a third reservoir arranged to receive therein a solvent for cleaning the blending chamber, the set of outlet passageways and/or the set of deposition nozzles;
wherein the set of pumps includes a third pump arranged to pump the solvent from the third reservoir; and
wherein the set of inlet passageways includes a third inlet passageway.

4. The vehicle according to claim 1, wherein the first pump includes a peristaltic pump.

5. The vehicle according to claim 1, wherein the first deposition nozzle is arranged forwardly of the set of wheels, forwardly of the first wheel, and/or forwardly of the set of tracks.

6. The vehicle according to claim 1, wherein the first deposition nozzle is arranged aligned with the set of wheels, preferably aligned with the first wheel, and/or aligned with the set of tracks.

7. The vehicle according to claim 1, further comprising a set of sensors including a first sensor arranged to sense an obstacle and to transmit a first signal to the controller, in response to sensing the obstacle.

8. The vehicle according to claim 7, wherein the controller is arranged to receive the first signal transmitted by the first sensor and to control the propulsion system and/or the deposition apparatus, based, at least in part, on the received first signal.

9. The vehicle according to claim 8, wherein the controller is arranged to control the propulsion system to move the vehicle rearwardly or forwardly and to control the deposition apparatus to deposit the foam, based, at least in part, on the received first signal.

10. The vehicle according to claim 9, wherein the controller is arranged to control the propulsion system to move the vehicle rearwardly and to control the deposition apparatus to deposit the foam, based, at least in part, on the received first signal, while the vehicle moves rearwardly.

11. The vehicle according to claim 10, wherein the controller is arranged to control the propulsion system to move the vehicle forwardly after depositing the foam.

12. The vehicle according to claim 9, wherein the controller is arranged to control the propulsion system to move the vehicle forwardly and to control the deposition apparatus to deposit the foam, based, at least in part, on the received first signal, while the vehicle moves forwardly.

13. A method of controlling a vehicle according to claim 1 to deposit a foam comprising a polymeric composition, the method comprising:
blending, using the blending chamber, the first component and the second component of the polymeric composition to provide the precursor of the polymeric composition;
generating the foam, at least in part, by mixing, using the static mixer included in the first deposition nozzle, the precursor; and
depositing the foam, at least in part, via the first deposition nozzle.

14. A deposition apparatus for depositing a foam comprising a polymeric composition, the deposition apparatus comprising:
a set of reservoirs, including a first reservoir and a second reservoir arranged to receive therein a first component and a second component of the polymeric composition, respectively;
a set of pumps, including a first pump and a second pump arranged to pump the first component and the second component from the first reservoir and the second reservoir, respectively;
a blending chamber in fluid communication with the set of reservoirs via a set of inlet passageways, including a first inlet passageway and a second inlet passageway, wherein the blending chamber is arranged to blend the first component and the second component therein to provide a precursor of the polymeric composition; and
a set of deposition nozzles in fluid communication with the blending chamber via a set of outlet passageways including a first outlet passageway, the set of deposition nozzles including a first deposition nozzle comprising a static mixer arranged to mix the precursor to generate the foam, at least in part, therefrom.

15. A method of depositing a foam comprising a polymeric composition, the method comprising:
blending, using a blending chamber, a first component and a second component of the polymeric composition to provide a precursor of the polymeric composition;
generating the foam, at least in part, by mixing, using a static mixer included in a first deposition nozzle, the precursor; and
depositing the foam, at least in part, via the first deposition nozzle.

16. (canceled)

17. The vehicle according to claim 5, wherein the first deposition nozzle is arranged forwardly of the first track.

18. The vehicle according to claim 6, wherein the first deposition nozzle is arranged aligned with the first track.
